(19) United States
(12) Patent Application Publication
(10) Pub. No.: US 2003/0012107 A1
(43) Pub. Date: Jan. 16, 2003

(54) Optical disk initialization apparatus and method

(76) Inventors: Kenji Fukui, Sagamihara-city (JP); Masahiko Ujiie, Iwata-city (JP); Kaname Arimizu, Hamamatsu-city (JP); Hirofumi Ikeya, Hamamatsu-city (JP); Takaya Toyoma, Hamamatsu-city (JP)

Correspondence Address: FISH & RICHARDSON, PC, 4350 LA JOLLA VILLAGE DRIVE, SUITE 500, SAN DIEGO, CA, 92122, US

(21) Appl. No.: 10/192,088

(22) Filed: Jul. 9, 2002

(30) Foreign Application Priority Data
Jul. 10, 2001 (JP) 2001-210044

(51) Int. Cl. G11B 7/125

(52) U.S. Cl. 369/53.25; 369/121; 369/116

(57) ABSTRACT

An optical disc initialization apparatus includes a table on which an optical disc is placed. The table is guided on a base for linear motion and is moved back and forth by an electric motor. A light source and an optical system are disposed above the table. The light source consists of a plurality of semiconductor laser arrays, each including a plurality of emitters arranged in a row and each emitting a laser beam. The optical system introduces the laser beams from the light source and forms an elongated elliptical laser spot on the optical disc. The major axis of the elliptical laser spot has a length substantially equal to the diameter of a recording area of the optical disc. The table is moved linearly under the optical system in order to initialize the entire recording area of the optical disc through a single scanning operation.

### BACKGROUND OF THE INVENTION

1. Field of the Invention

The present invention relates to an optical disc initialization apparatus and method for initializing optical discs through radiation of a laser beam thereonto.

2. Description of the Related Art

In a conventional known method for initializing a phase-change-type optical disc, a laser beam is radiated onto a recording area of the optical disc in order to heat the recording area to a temperature higher than the crystallization temperature but lower than the melting point; and the temperature of the recording area is then lowered gradually in order to uniformly crystallize the recording area. In this case, as in the case in which data are written to an optical disc or data are read therefrom, while focus-servo control is being effected, an initialization head is moved relative to a rotating optical disc, from the outer circumference to the inner circumference, or from the inner circumference to the outer circumference, to thereby initialize the optical disc spirally.

In general, during such initialization of an optical disc, a laser beam is radiated onto a recording area of the optical disc on a track-by-track basis. However, in a known initialization method disclosed in, for example, Japanese Patent Application Laid-Open (kokai) No. 2000-40243, a wide laser beam emitted from a semiconductor laser array (a multi-stripe laser diode) composed of a plurality of emitters arranged in a row is passed through an optical system consisting of, for example, a diffraction grating and cylindrical lenses in order to form an elliptical laser spot on the optical disc, to thereby initialize a plurality of tracks simultaneously. In another known initialization method disclosed in, for example, Japanese Patent Application Laid-Open (kokai) No. 4-271019, a laser beam is radiated onto an optical disc with the optical axis of the laser beam inclined in a tangential direction of the optical disc, so that after the recording section of the optical disc has been heated to a temperature higher than the crystallization temperature upon irradiation with the laser beam, the temperature of the recording section lowers at a slow speed, whereby the recording area is uniformly crystallized under improved conditions in order to initialize the optical disc in an improved manner.

However, even when, as in the above-described conventional technique, a plurality of tracks are initialized simultaneously by use of an initialization apparatus which utilizes a semiconductor laser array composed of a plurality of emitters arranged in a row, since the width of the laser spot is limited, an optical disc must be rotated a plurality of times in order to initialize the entire recording area of the optical disc. Therefore, the conventional technique requires a very long time to initialize the entire recording area of the optical disc.

### SUMMARY OF THE INVENTION

The prevent invention has been accomplished in order to cope with the above-described problems, and an object of the present invention is to provide an optical disc initialization apparatus and method which can initialize an optical disc efficiently within a shortened period of time.

In order to achieve the above object, the present invention provides an optical disc initialization apparatus in which a laser beam from a light source is radiated onto an optical disc via an optical system to thereby initialize the optical disc, wherein the light source includes a plurality of semiconductor laser arrays each having a plurality of emitters arranged in a row, the semiconductor laser arrays being disposed in such a manner that all the emitters among all the semiconductor laser arrays are arranged along the same direction.

The optical system may be configured through combined use of cylindrical lenses only, or through combined use of cylindrical lenses and other optical elements such as a diffraction grating, a spherical lens, and a stop. A laser spot of an elongated elliptical shape is preferably formed on the optical disc. For example, the length of the major axis is set to 40 mm to 400 mm; and the length of the minor axis is set to 0.2 mm or less.

In the present invention, since the light source is constituted by a plurality of semiconductor laser arrays each having a plurality of emitters arranged in a row and disposed in such a manner that all the emitters among all the semiconductor laser arrays are arranged along the same direction, a wide laser spot can be formed on an optical disc. Therefore, an optical disc can be initialized efficiently within a short period of time. For example, an optical disc can be initialized through an operation of linearly scanning the entirety of the upper surface of the optical disc one time by means of a laser spot wider than the diameter of the recording area of the optical disc. Alternatively, an optical disc can be initialized through an operation of circumferentially scanning the entirety of the upper surface of the optical disc one time by means of a laser spot wider than the radial width of the recording area of the optical disc.

Further, the optical system is desirably configured to have a large focal depth of, for example, 50 μm to 200 μm, more preferably 100 μm to 160 μm, thereby eliminating the necessity of performing focus control of the optical system.

Preferably, a plurality of drive units are provided in order to individually control the plurality of semiconductor laser arrays in order to control the output energies of the emitters on an array-by-array basis. In this case, the plurality of semiconductor laser arrays can be adjusted in order to reduce variation in radiation intensity along the width direction of the laser spot (the direction of the major axis of the ellipse) to thereby enable uniform initialization of the optical disc. In addition, the radiation intensity can be decreased locally along the width direction of the laser spot (the direction of the major axis of the ellipse) if need be. Therefore, damage of a portion of the optical disc which does not require laser radiation (e.g., generation of cracks in a portion on the radially inward side of the recording area) due to laser radiation can be avoided.

The present invention provides another optical disc initialization apparatus comprising a table on which an optical disc is placed; a light source including a plurality of emitters arranged in a row and each emitting a laser beam; an optical system for introducing the laser beams from the light source and for forming on the optical disc an elongated laser spot having a length equal to or greater than a diameter of a recording area of the optical disc; and a moving mechanism for driving the table or driving the light source and the optical system in order to move the table relative to the light source and the optical system along a direction parallel to an upper surface of the optical disc and perpendicular to the major axis of the laser spot, wherein the optical disc is initialized through linear scanning of the upper surface of the optical disc by means of the laser spot.

In the optical disc initialization apparatus configured as described above, the moving mechanism moves the table relative to the light source and the optical system in order to linearly scan an upper surface of the optical disc by means of an elongated laser spot having a length equal to or greater than the diameter of the recording area of the optical disc, whereby the optical disc is initialized. Since the entire recording area of an optical disc can be initialized through a single cycle of operation of linearly scanning the entire upper surface of the optical disc, the optical disc can be initialized efficiently within a short period of time.

Preferably, the optical disc initialization apparatus which linearly scans an optical disc by means of a laser spot further comprises a position detection unit for detecting relative position of the laser spot with respect to the optical disc, the position changing in accordance with relative movement of the table with respect to the light source and the optical system; and a drive unit for controlling output energies of the plurality of emitters of the light source in accordance with the relative position detected by means of the position detection unit. By virtue of this configuration, the radiation intensity within the laser spot can be decreased locally along the direction of the major axis of the laser spot in accordance with the relative position of the laser spot with respect to the optical disc, whereby the radiation intensity of the laser beam can be decreased at a location where radiation of the laser beam is unnecessary; e.g., a portion on the radially inward side of the recording area of the optical disc. Accordingly, partial damage of an optical disc caused by laser radiation, such as generation of cracks in the portion inside the recording area caused by laser radiation, can be avoided.

In this case, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and the drive unit is individually provided for each of the plurality of semiconductor laser arrays in order to control the output energies of the emitters of the plurality of semiconductor laser arrays on an array-by-array basis. By virtue of this configuration, the above-described control of partially changing the radiation intensity along the direction of the major axis of the laser spot can be performed by use of a simple structure.

Preferably, the optical disc initialization apparatus which linearly scans an optical disc by means of a laser spot further comprises: a velocity detection unit for detecting relative velocity of the table with respect to the light source and the optical system; and a drive unit for controlling output energies of the plurality of emitters of the light source in accordance with the relative velocity detected by means of the velocity detection unit. By virtue of this configuration, the radiation intensity within the laser spot can be controlled in accordance with the relative velocity, so that the optical disc can be initialized homogeneously even when the relative velocity of the optical disc with respect to the laser spot varies.

In this case as well, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and the drive unit is individually provided for each of the plurality of semiconductor laser arrays in order to control the output energies of the emitters of the plurality of semiconductor laser arrays on an array-by-array basis. By virtue of this configuration, the above-described control of partially changing the radiation intensity along the major axis direction of the laser spot can be performed by use of a simple structure.

In the optical disc initialization apparatus which linearly scans an optical disc by means of a laser spot, the moving mechanism is preferably configured to reciprocate the table relative to the light source and the optical system. By virtue of this configuration, two optical discs can be initialized by means of a single cycle of the tabale reciprocation, so that optical discs can be initialized efficiently within a short period of time. In addition, since the moving mechanism for reciprocating the table has a relatively simple structure, the structure of the optical disc initialization apparatus does not become excessively complex.

Preferably, the optical disc initialization apparatus which linearly scans an optical disc by means of a laser spot further comprises an energy intensity distribution detection unit provided on the table and adapted to detect intensity distribution of radiation energy of the laser beam along the direction of the major axis of the laser spot. This configuration enables an operation of initializing an optical disc while checking the intensity distribution of radiation energy of the laser beam along the direction of the major axis of the laser spot. Therefore, the entire recording area of the optical disc can be initialized homogeneously at all times.

Preferably, the optical disc initialization apparatus which linearly scans an optical disc by means of a laser spot further comprises a tilt mechanism for tilting the optical axis of the laser beam from the light source and the optical system in a direction in which the table moves relative to the light source and the optical system. By virtue of this configuration, after having been heated to a temperature higher than the crystallization temperature upon radiation of the laser beam, the recording area of an optical disc cools slowly, so that the recording area is crystallized uniformly under improved conditions, and thus the optical disc can be initialized under improved conditions.

The present invention provides still another optical disc initialization apparatus comprising a table on which an optical disc is placed; a light source including a plurality of emitters arranged in a row and each emitting a laser beam; an optical system for introducing the laser beams from the light source and for forming an elongated laser spot on the optical disc, the elongated laser spot having a length equal to or greater than a radial width of a recording area of the optical disc, and having a major axis which extends radially with respect to the optical disc; and a rotation mechanism for rotating the table or the light source and the optical system in order to rotate the table relative to the light source and the optical system, wherein the optical disc is initialized through circumferential scanning of the upper surface of the optical disc by means of the laser spot.

In the optical disc initialization apparatus configured as described above, the rotation mechanism rotates the table relative to the light source and the optical system in order to circumferentially scan an upper surface of the optical disc by means of an elongated laser spot having a length equal to or greater than the radial width of the recording area of the optical disc, whereby the optical disc is initialized. Since the entire recording area of an optical disc can be initialized through an operation of rotating by one turn the optical disc relative to the light source and the optical system, the optical disc can be initialized efficiently within a short period of time.

Preferably, the optical disc initialization apparatus which circumferentially scans an optical disc by means of a laser spot further comprises a drive unit for adjusting output energies of the plurality of emitters of the light source. By virtue of this configuration, the radiation intensity within the laser spot can be changed in the radial direction; i.e., the radiation intensity within the laser spot can be decreased toward the center of the optical disc. Therefore, the radiation intensity at each of radial positions of the optical disc can be set in proportion to linear velocity at the corresponding radial position, so that the optical disc can be initialized homogeneously along the radial direction.

In this case, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and the drive unit is individually provided for each of the plurality of semiconductor laser arrays in order to adjust the output energies of the emitters of the plurality of semiconductor laser arrays on an array-by-array basis. By virtue of this configuration, the above-described operation of partially adjusting the radiation intensity along the direction of the major axis of the laser spot can be performed by use of a simple structure.

Preferably, the optical disc initialization apparatus which circumferentially scans an optical disc by means of a laser spot further comprises an angular velocity detection unit for detecting angular velocity of the table; and a drive unit for controlling output energies of the plurality of emitters of the light source in accordance with the angular velocity detected by means of the angular velocity detection unit. By virtue of this configuration, the radiation intensity within the laser spot can be controlled in accordance with the angular velocity, so that the optical disc can be initialized homogeneously even when the angular velocity of the optical disc varies.

In this case as well, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and the drive unit is individually provided for each of the plurality of semiconductor laser arrays in order to control the output energies of the emitters of the plurality of semiconductor laser arrays on an array-by-array basis. By virtue of this configuration, the above-described control of partially changing the radiation intensity along the direction of the major axis of the laser spot can be performed by use of a simple structure.

Preferably, the optical disc initialization apparatus which circumferentially scans an optical disc by means of a laser spot further comprises a tilt mechanism for tilting the optical axis of the laser beam from the light source and the optical system in a tangential direction of the optical disc. By virtue of this configuration, after having been heated to a temperature higher than the crystallization temperature upon radiation of the laser beam, the recording area of an optical disc cools slowly, so that the recording area is crystallized uniformly under improved conditions, and thus the optical disc can be initialized under improved conditions.

According to another aspect of the present invention, there is provided an optical disc initialization method comprising providing a table on which an optical disc is placed, a light source including a plurality of emitters arranged in a row and each emitting a laser beam, and an optical system for introducing the laser beams from the light source and for forming on the optical disc an elongated laser spot having a length equal to or greater than a diameter of a recording area of the optical disc; and driving the table or driving the light source and the optical system in order to move the table relative to the light source and the optical system along a direction parallel to an upper surface of the optical disc and perpendicular to the major axis of the laser spot, whereby the upper surface of the optical disc is linearly scanned for initialization by means of the laser spot.

When the optical disc initialization method is used, the entire recording area of an optical disc can be initialized through a single cycle of operation of linearly scanning the entire upper surface of the optical disc. Therefore, the optical disc can be initialized efficiently within a short period of time.

Preferably, the optical disc initialization method which linearly scans an optical disc by means of a laser spot further comprises detecting relative position of the laser spot with respect to the optical disc, the position changing in accordance with relative movement of the table with respect to the light source and the optical system; and controlling output energies of the plurality of emitters of the light source in accordance with the detected relative position in order to reduce the radiation intensity of the laser beam at a portion located on the inward side of the recording area of the optical disc. This method protects a portion which is susceptible to thermal damage (generation of cracks), such as the portion located on the inward side of the recording area, so that the optical disc is not damaged by the initialization.

In this case as well, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and the output energies of the emitters of the plurality of semiconductor laser arrays are controlled on an array-by-array basis. By virtue of this, the above-described control of partially changing the radiation intensity along the direction of the major axis of the laser spot can be performed by use of a simple structure.

Preferably, the optical disc initialization method which linearly scans an optical disc by means of a laser spot further comprises detecting relative velocity of the table with respect to the light source and the optical system; and controlling output energies of the plurality of emitters of the light source in accordance with the detected relative velocity in order to increase the radiation intensity of the laser beam with the relative velocity. When this method is employed, the radiation intensity within the laser spot can be controlled in accordance with the relative velocity, so that the optical disc can be initialized homogeneously even when the relative velocity of the optical disc with respect to the laser spot varies.

In this case, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and control of output energies of the plurality of emitters of the light source is individually performed for each of the plurality of semiconductor laser arrays. In this case as well, the above-described control of partially changing the radiation intensity along the direction of the major axis of the laser spot can be performed by use of a simple structure.

Preferably, the optical disc initialization method which linearly scans an optical disc by means of a laser spot further comprises reciprocating the table relative to the light source and the optical system. By virtue of this method, two optical discs can be initialized by means of a single cycle of the table reciprocation, so that optical discs can be initialized efficiently within a short period of time.

Preferably, the optical disc initialization method which linearly scans an optical disc by means of a laser spot further comprises detecting intensity distribution of radiation energy of the laser beam along the direction of the major axis of the laser spot so as to check the state of radiation of the laser beam onto the optical disc. This method enables an operation of initializing an optical disc while checking the intensity distribution of radiation energy of the laser beam along the direction of the major axis of the laser spot. Therefore, the entire recording area of the optical disc can be initialized homogeneously at all times.

Preferably, the optical disc initialization method which linearly scans an optical disc by means of a laser spot further comprises tilting the optical axis of the laser beam from the light source and the optical system in a direction in which the table moves relative to the light source and the optical system, in order to radiate an inclined laser beam onto the optical disc. By virtue of this method, after having been heated to a temperature higher than the crystallization temperature upon radiation of the laser beam, the recording area of an optical disc cools slowly, so that the recording area is crystallized uniformly under improved conditions, and thus the optical disc can be initialized under improved conditions.

Preferably, the optical disc initialization method which linearly scans an optical disc by means of a laser spot further comprises attaching a cap to a portion of the optical disc located on inward side of the recording area thereof in order to prevent the laser beam from reaching that portion; and radiating the laser beam onto the optical disc in this state. When this method is used, since the cap prevents the laser beam from reaching the portion located on the inward side of the recording area of the optical disc, the portion located inside the recording area does not suffer thermal damage such as generation of cracks.

The present invention provides another optical disc initialization method comprising providing a table on which an optical disc is placed, a light source including a plurality of emitters arranged in a row and each emitting a laser beam, and an optical system for introducing the laser beams from the light source and for forming on the optical disc an elongated elliptical laser spot having a length equal to or greater than a radial width of a recording area of the optical disc and having a major axis extending radially with respect to the optical disc; and driving the table or driving the light source and the optical system in order to rotate the table relative to the light source and the optical system, whereby the upper surface of the optical disc is circumferentially scanned for initialization by means of the laser spot.

When this initialization method is used, the entire recording area of an optical disc can be initialized through an operation of rotating the optical disc one turn, whereby the optical disc can be initialized efficiently within a short period of time.

Preferably, the optical disc initialization method which circumferentially scans an optical disc by means of a laser spot further comprises adjusting output energies of the plurality of emitters of the light source in order to reduce the radiation intensity imparted to the optical disc in accordance with the inward radial position of the optical disc. When this method is used, the radiation intensity at each of radial positions of the optical disc can be set substantially in proportion to linear velocity at the corresponding radial position, so that the optical disc can be initialized homogeneously along the radial direction.

In this case, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and adjustment of output energies of the plurality of emitters of the light source is individually performed for each of the plurality of semiconductor laser arrays. In this case, the above-described operation of partially adjusting the radiation intensity along the direction of the major axis of the laser spot can be performed by use of a simple structure.

Preferably, the optical disc initialization method which circumferentially scans an optical disc by means of a laser spot further comprises detecting angular velocity of the table; and controlling output energies of the plurality of emitters of the light source in accordance with the detected angular velocity in order to increase the output energies of the emitters with the angular velocity. By virtue of this method, the radiation intensity within the laser spot can be controlled in accordance with the angular velocity, so that the optical disc can be initialized homogeneously even when the angular velocity of the optical disc varies.

In this case as well, preferably, the light source includes a plurality of semiconductor laser arrays each having a plurality of emitters arranged in a row, the semiconductor laser arrays being disposed in such a manner that all the emitters among all the semiconductor laser arrays are arranged along the same direction; and control of output energies of the emitters of the light source is individually performed for each of the plurality of semiconductor laser arrays. In this case, the above-described operation of partially controlling the radiation intensity along the direction of the major axis of the laser spot can be performed by use of a simple structure.

Preferably, the optical disc initialization method which circumferentially scans an optical disc by means of a laser spot further comprises tilting the optical axis of the laser beam from the light source and the optical system in a tangential direction of the optical disc in order to radiate an inclined laser beam onto the optical disc. By virtue of this method, after having been heated to a temperature higher than the crystallization temperature upon radiation of the laser beam, the recording area of an optical disc cools slowly, so that the recording area is crystallized uniformly under improved conditions, and thus the optical disc can be initialized under improved conditions.

Preferably, the optical disc initialization method which circumferentially scans an optical disc by means of a laser spot further comprises attaching a cap to a portion of the optical disc located on inward side of the recording area thereof in order to prevent the laser beam from reaching that portion; and radiating the laser beam onto the optical disc in this state. This method protects a portion which is susceptible to thermal damage (generation of cracks), such as the portion located on the inward side of the recording area, so that the optical disc is not damaged by the initialization.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic perspective view showing the basic configuration of an optical disc initialization apparatus according to an embodiment of the present invention;

FIG. 2 is a schematic perspective view showing a specific example of the semiconductor laser array shown in FIG. 1;

FIG. 3 is a plan view of a radiation spot of a laser beam produced by means of the light source and the optical system shown in FIG. 1;

FIG. 4 is a schematic perspective view showing one example of the optical system shown in FIG. 1;

FIG. 5 is a schematic perspective view showing another example of the optical system shown in FIG. 1;

FIG. 6 is a schematic perspective view showing another example of the optical system shown in FIG. 1;

FIG. 7 is a schematic perspective view showing another example of the optical system shown in FIG. 1;

FIG. 8 is a schematic perspective view showing another example of the optical system shown in FIG. 1;

FIG. 9 is a schematic perspective view showing a structural example of an initialization apparatus which initializes an optical disc by use of the basic configuration shown in FIG. 1;

FIG. 10 is a schematic sectional view showing the structure of the table shown in FIG. 9;

FIG. 11 is an enlarged perspective view of a light shield plate and a radiation-energy-distribution detector shown in FIG. 10;

FIG. 12 is a perspective view of an example optical disc;

FIGS. 13A to 13C are schematic perspective views used for explaining an optical disc initialization operation executed by the initialization apparatus of FIG. 9;

FIG. 14 is a graph showing the results of measurement of an radiation-energy intensity distribution of an laser spot performed by use of the radiation-energy-distribution measurement unit shown in FIG. 9;

FIGS. 15A to 15E are schematic perspective views used for explaining radiation statuses of a laser beam during the optical disc initialization operation executed by the initialization apparatus of FIG. 9;

FIGS. 16A and 16B are views used for explaining a state in which a laser beam is tilted by means of the tilt mechanism shown in FIG. 9, wherein FIG. 16A is a schematic view of the light source, the optical system, and the optical disc, as viewed in the Y-axis direction, and FIG. 16B is a schematic view of the light source, the optical system, and the optical disc, as viewed in the X-axis direction;

FIG. 17A is a graph showing the intensity distribution of an irradiation spot of a laser beam in the case in which the optical axis of the laser beam is tilted from the vertical axis, and FIG. 17B is a graph showing the intensity distribution of an irradiation spot of the laser beam in the case in which the optical axis of the laser beam is oriented perpendicular to the optical disc;

FIG. 18A is a graph showing variation, with time, of the temperature of the optical disc in the case in which the optical axis of the laser beam is tilted from the vertical axis, and FIG. 18B is a graph showing variation, with time, of the temperature of the optical disc in the case in which the optical axis of the laser beam is oriented perpendicular to the optical disc;

FIG. 19 is a schematic perspective view showing the entirety of one modification of the initialization apparatus of FIG. 9;

FIG. 20 is a schematic perspective view showing a portion of another modification of the initialization apparatus of FIG. 9;

FIG. 21 is a schematic perspective view showing the entirety of still another modification of the initialization apparatus of FIG. 9;

FIG. 22 is a schematic perspective view showing the entirety of still another modification of the initialization apparatus of FIG. 9;

FIG. 23 is a graph showing distribution of energy (quantity) of light radiated onto an optical disc in the initialization apparatus of FIG. 22; and

FIG. 24 is a perspective view showing a state in which a protection cap has been attached to an optical disc.

### DESCRIPTION OF THE PREFERRED EMBODIMENT

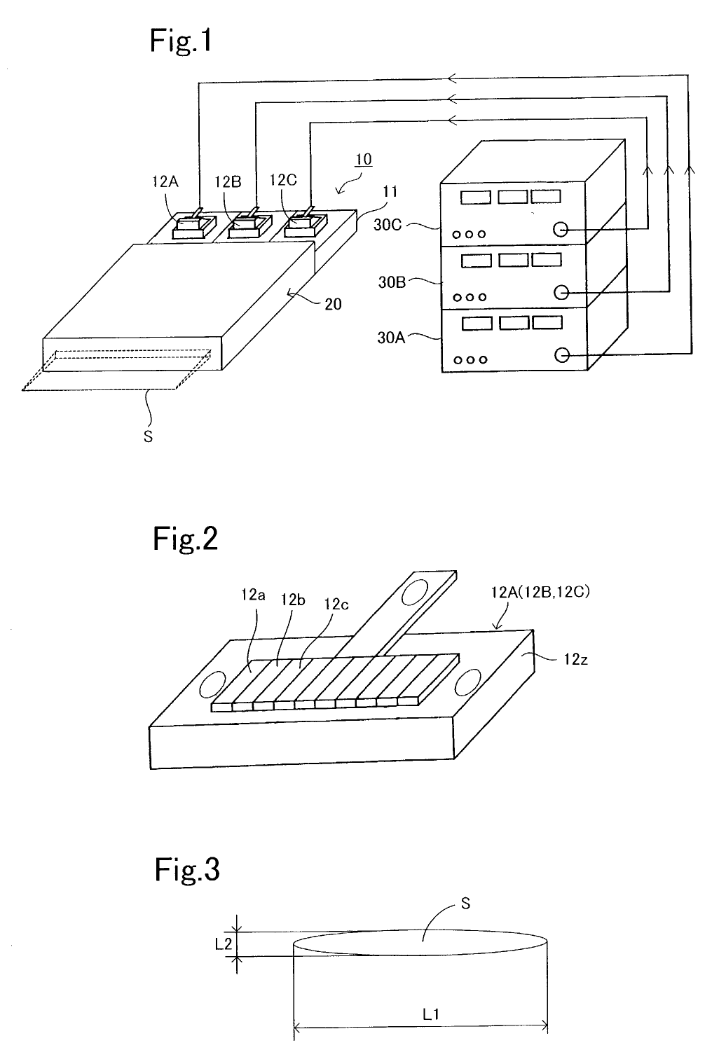

An embodiment of the present invention will now be described with reference to the drawings. FIG. 1 schematically shows the basic configuration of an optical disc initialization apparatus according to the embodiment. This initialization apparatus includes a light source 10 for emitting a laser beam; and an optical system 20, which introduces the emitted laser beam and forms a laser spot S at a predetermined irradiation position.

The light source 10 includes a plurality of semiconductor laser arrays 12A, 12B, and 12C, which are arranged in a row on a base 11 and fixed thereto. As shown in FIG. 2, each of the semiconductor laser arrays 12A, 12B, and 12C has a plurality of (e.g., 16 to 100) emitters 12a, 12b, 12c, etc., each constituted by a semiconductor laser element for emitting a laser beam. These emitters 12a, 12b, 12c, etc. are arranged in a row on a base 12z, the row extending perpendicular to the optical axis of the laser beam. The plurality of emitters 12a, 12b, 12c, etc. are arranged along the same direction in each of the semiconductor laser arrays 12A, 12B, and 12C, and therefore, a large number of emitters are arranged in a row.

In FIG. 1, three semiconductor laser arrays 12A, 12B, and 12C are shown. However, the number of the semiconductor laser arrays 12A, 12B, and 12C is not limited to three, insofar as the number is not less than 2. Preferably, more than three semiconductor laser arrays are provided. For example, eight semiconductor laser arrays are fixedly disposed on the base 11. The total light energy of a laser beam emitted from the light source 10 is set to about 30 W to 1,000 W, preferably to about 300 W to 500 W.

The optical system 20 is composed of a plurality of lens and other optical elements combined appropriately, and, as shown in FIG. 3, forms a laser spot S on an optical disc. The laser spot S has the shape of an ellipse elongated in a direction perpendicular to the optical axis. The length of the major axis L1 of the ellipse is set to 40 mm to 400 mm; and the length of the minor axis L2 of the ellipse is set to 0.2 mm or less.

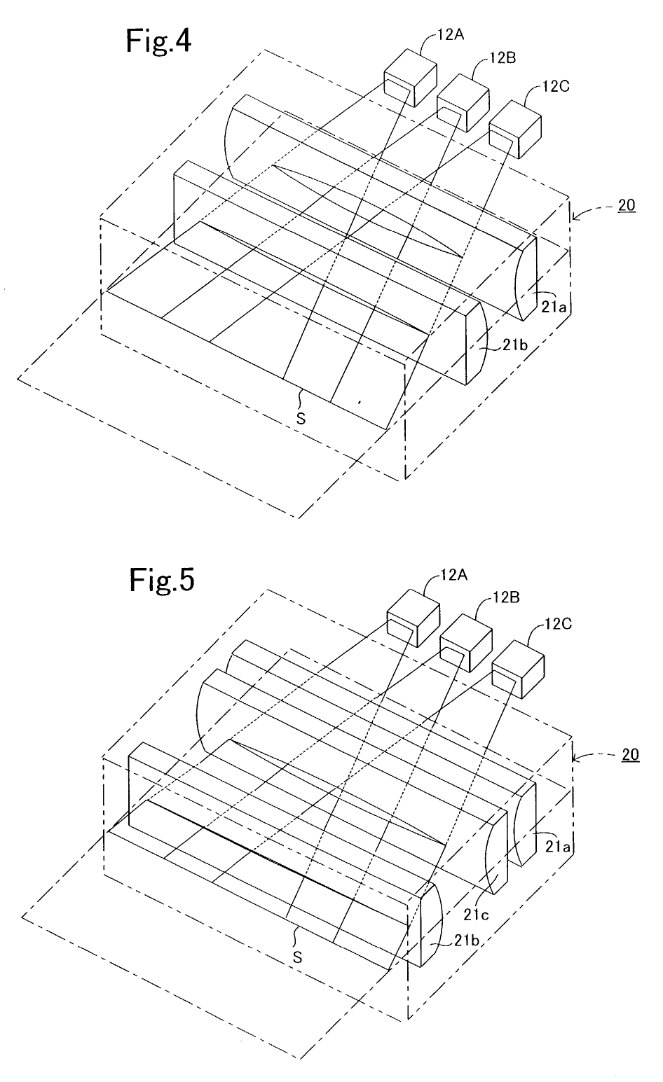

Next, various specific examples of the optical system 20 will be described. In one example of the optical system 20, as shown in FIG. 4, two cylindrical lenses 21a and 21b are disposed in series along a propagation direction of the laser beam. Each of the cylindrical lenses 21a and 21b has a generating line parallel to the direction in which the semiconductor laser arrays 12A, 12B, and 12C are arranged (i.e., the direction in which the emitters 12a, 12b, 12c, etc. are arranged). In another example of the optical system 20, as shown in FIG. 5, another cylindrical lens 21c is disposed between the cylindrical lenses 21a and 21b of FIG. 4. The cylindrical lens 21c has a generating line parallel to those of the cylindrical lenses 21a and 21b. By means of these cylindrical lenses 21a to 21c, the laser beams emitted from the semiconductor laser arrays 12A, 12B, and 12C are converged in the vertical direction (the direction of the minor axis in FIG. 3).

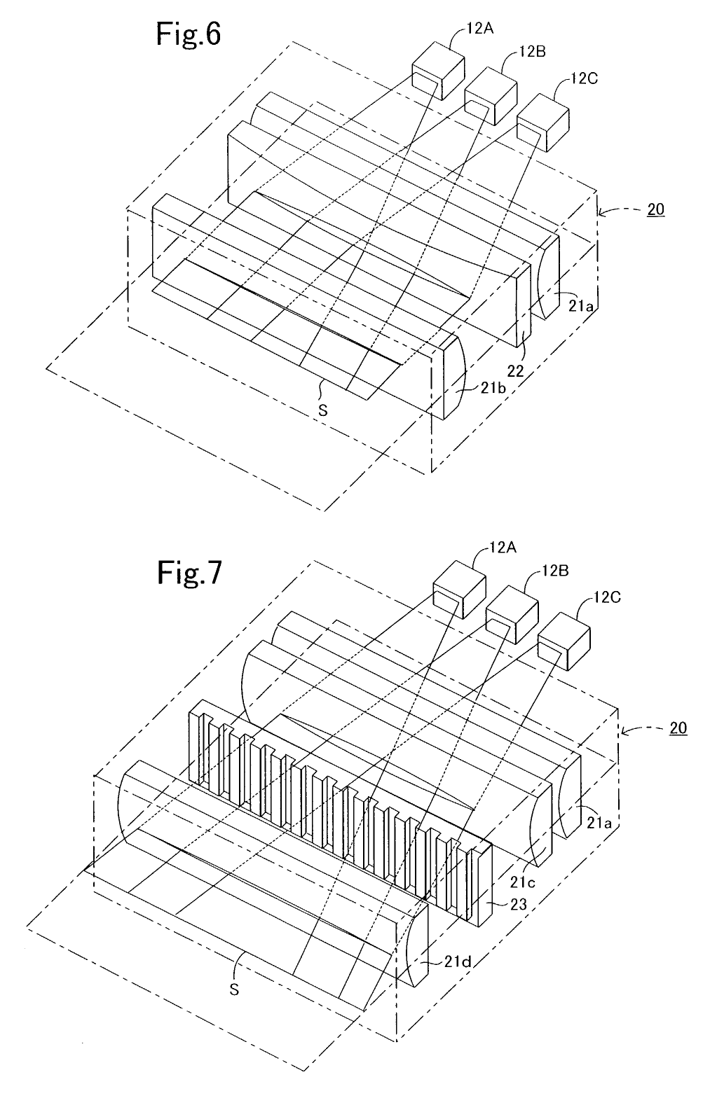

In still another example of the optical system 20, as shown in FIG. 6, in place of the cylindrical lens 21c of FIG. 5, a cylindrical lens 22 having a generating line perpendicular to those of the cylindrical lenses 21a and 21b (extending in the vertical direction) is disposed between the cylindrical lenses 21a and 21b. By means of the cylindrical lens 22, the laser beams emitted from the semiconductor laser arrays 12A, 12B, and 12C are converged slightly in the horizontal direction (the direction of the major axis in FIG. 3), as compared to the optical system 20 of FIG. 4 and the optical system 20 of FIG. 5.

In still another example of the optical system 20, as shown in FIG. 7, a cylindrical lens 21 disused in place of the cylindrical lens 21b of FIG. 5; and a diffraction grating 23 is disposed between the cylindrical lenses 21c and 21d. The cylindrical lens 21d has a generating line parallel to those of the cylindrical lenses 21a and 21c and a partial cylindrical surface which faces the propagation direction of the laser beam, unlike the cylindrical lens 21b of FIG. 5 whose flat surface faces the propagation direction of the laser beam. In the diffraction grating 23, grooves are formed to extend along a direction perpendicular to the generating lines of the cylindrical lenses 21a, 21c, and 21d. By means of the diffraction grating 23, the laser beams emitted from the semiconductor laser arrays 12A, 12B, and 12C are diverged in the horizontal direction (the direction of the major axis in FIG. 3), as compared to the optical system 20 of FIG. 4, the optical system 20 of FIG. 5, and the optical system 20 of FIG. 6, whereby variation in illumination in the horizontal direction can be eliminated.

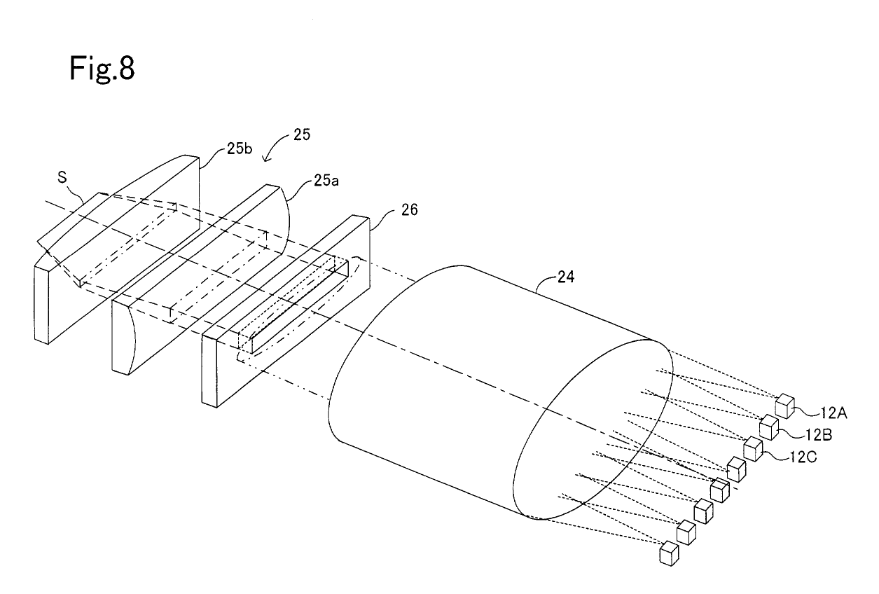

In still another example of the optical system 20, as shown in FIG. 8, a first optical-element group 24 and a second optical-element group 25 are disposed in series along the propagation direction of the laser beam; and a stop 26 is disposed between the first and second optical-element groups 24 and 25. The first optical-element group 24 is composed of a plurality of lenses, including spherical lens, combined appropriately and has a function of a collimating lens for converting the laser beams emitted from the semiconductor laser arrays 12A, 12B, and 12C to parallel light beams.

The second optical-element group 25 is composed of cylindrical lenses 25a and 25b. The cylindrical lens 25a has a generating line parallel to the direction in which the semiconductor laser arrays 12A, 12B, and 12C are arranged. Therefore, the laser beams emitted from the semiconductor laser arrays 12A, 12B, and 12C are converged in the vertical direction (the direction of the minor axis in FIG. 3). The cylindrical lens 25b has a generating line (extending in the vertical direction) perpendicular to the generating line of the cylindrical lens 25a. Therefore, the laser beams emitted from the semiconductor laser arrays 12A, 12B, and 12C are converged slightly in the horizontal direction (the direction of the major axis in FIG. 3). The stop 26 has an aperture of predetermined size and shuts off unnecessary peripheral light rays.

As described above, the optical system 20 can be configured through combined use of cylindrical lenses only, or through combined use of cylindrical lenses and other optical elements such as a diffraction grating, a spherical lens, and a stop. Any of various combinations can be used insofar as a laser spot S formed on an optical disc by means of laser beams assumes an elongated elliptical shape. It is important to configure the optical system 20 in such a manner that variation in illumination in the direction of the major axis of the laser spot S is reduced. Further, the optical system 20 is desirably configured to have a large focal depth of, for example, 50 μm to 200 μm, in order to obviate focus control. More preferably, the optical system 20 is configured to have a focal depth of about 100 μm to 160 Referring back to FIG. 1, drive units 30A, 30B, and 30C are connected to the semiconductor laser arrays 12A, 12B, and 12C, respectively. Notably, when the number of the semiconductor laser arrays is increased as described above, the number of the drive units is increased accordingly. The drive units 30A, 30B, and 30C individually control the output energies (light quantities) of laser beams emitted from the semiconductor laser arrays 12A, 12B, and 12C. In this case, the output energies of the laser beams are controlled in accordance with operation of operation knobs provided on the drive units 30A, 30B, and 30C or in accordance with various external signals supplied to the drive units 30A, 30B, and 30C.

Next, descriptions will be provided of a specific optical disc initialization apparatus using the above-described basic structure and an optical disc initialization method.

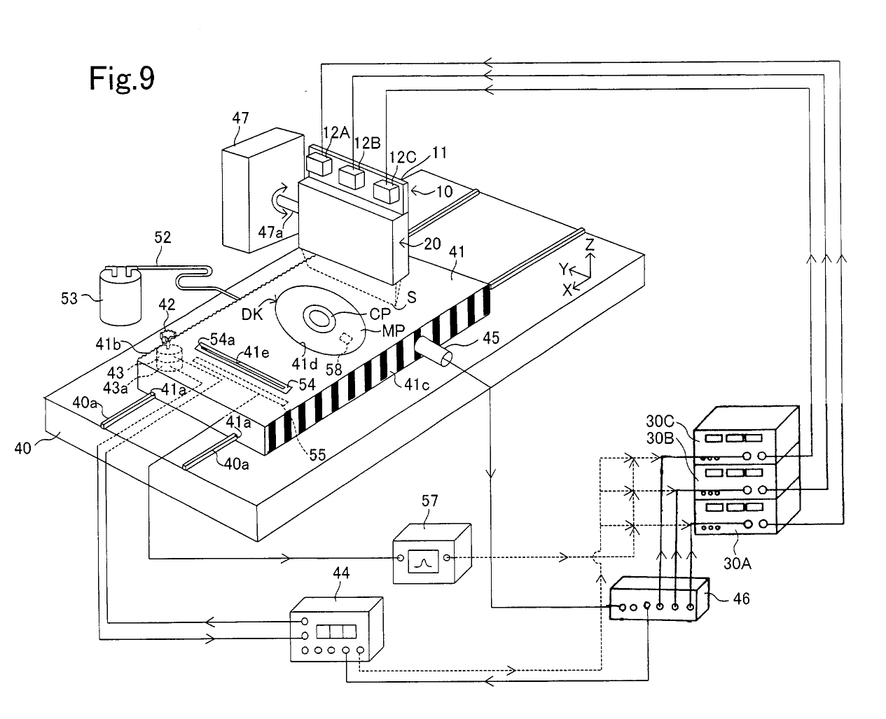

As shown in FIG. 9, the apparatus includes a rectangular table 41, which is mounted on a base 40 to be movable linearly (along the X-axis direction). A pair of parallel guide rails 40a, each extending along the X-axis direction, are provided on the base 40. The guide rails 40a are fitted into a pair of guide grooves 41a, which are formed on the bottom surface of the table 41 to extend along the X-axis direction. Thus, the guide rails 40a restrict movement of the table 41 in such a manner that the table 41 moves along the X-axis direction only. A rack gear 41b is formed on a left-hand side surface of the table 41 in FIG. 9, and a pinion gear 42 is in meshing-engagement with the rack gear 41b. The pinion gear 42 is rotated by means of an electric motor 43 in order to move the table 41 along the X-axis direction.

A drive control unit 44 is connected to the motor 43. The drive control unit 44 controls start and stop of operation of the motor 43 on the basis of the X-axis position of the table 41 relative to the base 40. An encoder 43a is built in the motor 43 in order to detect rotation of the rotor relative to the stator. A detection signal output from the encoder 43a and representing the detected rotation of the rotor relative to the stator (hereinafter, this signal will be referred to as a signal indicative of rotation of the motor 43) is also supplied to the drive control unit 44. The drive control unit 44 calculates the angular velocity of the motor 43 on the basis of the signal indicative of rotation of the motor 43, and controls the angular velocity of the motor 43 to a predetermined constant velocity by use of the thus-calculated angular velocity.

Code data for detecting the X-axis position of the table 41 relative to the base 40 are recorded magnetically or optically on the right-hand side surface 41c of the table 41. A position sensor 45 for reading the code data magnetically or optically is disposed to face the right-hand side surface 41c. The position sensor 45 is fixed to the base 40 via an unillustrated support member. The position sensor 45 is connected to a position detection unit 46. The position detection unit 46 calculates the X-axis position of the table 41 relative to the base 40 on the basis of a read signal from the position sensor 45, and outputs to the drive units 30A, 30B, and 30C a position detection signal which represents the calculated position.

As described above, the drive units 30A, 30B, and 30C individually control the output energies of the semiconductor laser arrays 12A, 12B, and 12C of the light source 10. The light source 10 and the optical system 20 are disposed above the table 41. In the present embodiment, the emitters 12a, 12b, 12c, etc. of the semiconductor laser arrays 12A, 12B, and 12C are arranged along the Y-axis direction, so that the laser beam emitted from the optical system 20 forms an elliptical laser spot S on the upper surface of the table 41 in such a manner that the major axis of the ellipse extends along the Y-axis direction. The length of the major axis of the laser spot S is set to a value slightly greater than the diameter of a recording area MP of an optical disc DK, which will be described later. As having been described in relation to the basic configuration, the number of the semiconductor laser arrays 12A, 12B, and 12C and the number of the drive units 30A, 30B, and 30C are desirably set to a number greater than 3; for example, about 8.

The light source 10 and the optical system 20 are tiltably supported by a tilt mechanism 47, which is fixed to the base 40 via an unillustrated support member. The tilt mechanism 47 is configured to rotate a rotary shaft 47a extending along the Y-axis direction, through manual operation or motor-driven operation. The optical system20 is fixed to the outer periphery of a tip end portion of the rotary shaft 47a. The tilt mechanism 47 enables the optical axis of a laser beam emitted from the light source 10 via the optical system 20 to be tilted by a desired angle relative to the Z-axis direction, which perpendicularly intersects the X-axis direction and the Y-axis direction.

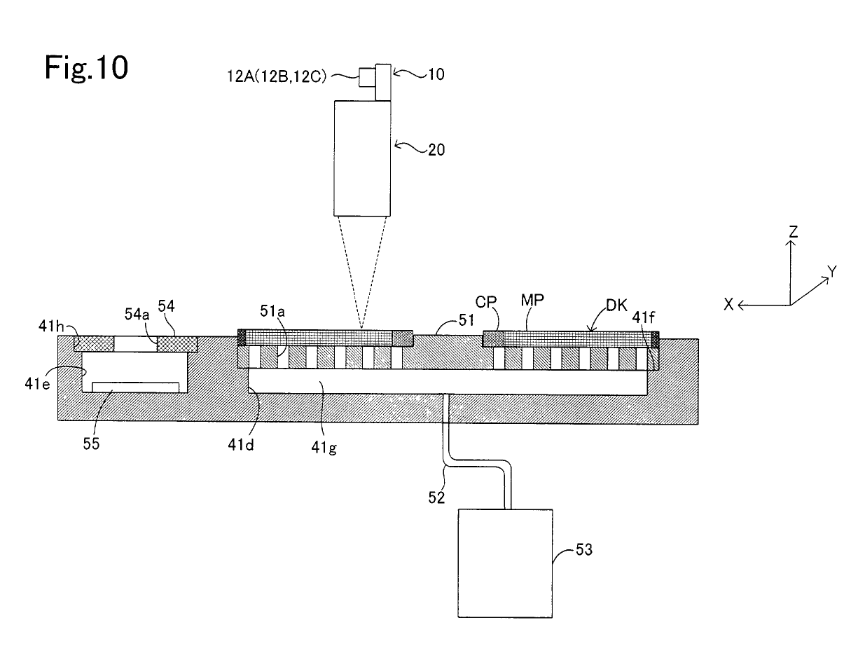

As shown in FIGS. 9 and 10, the table 41 has a circular depression 41d and an elongated depression 41e formed on the upper surface thereof. The circular depression 41d is located approximately at the center of the table 41, on the upper surface thereof. The elongated depression 41e is located on the front side with respect to the circular depression 41d and extends along the Y-axis direction. The circular depression 41d has a stepped portion 41f along the entire circumference thereof. A circular plate 51, on which the optical disc DK is placed, is fixed to the stepped portion 41f in an airtight manner. A vacuum chamber 41g is formed below the plate 51 and is connected to a pump 53 via a flexible tube 52. When operated, the pump 53 lowers the air pressure within the vacuum chamber 41g. A large number of through-holes are formed in a surface of the plate 51 through which the plate 51 comes in contact with the optical disc DK. Therefore, when the pump 53 is operated, the optical disc DK placed on the plate 51 is pulled downward against the plate 51.

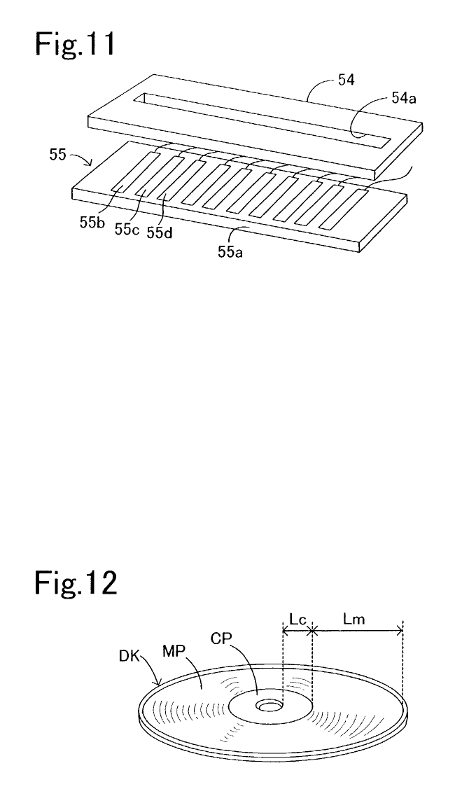

As shown in FIGS. 9 to 11, the depression 41e has a stepped portion 41h along the entire circumference thereof. A light shield plate 54 is fitted into the stepped portion 41h. The light shield plate 54 has a slit 54a, and aluminum is deposited on the entirety of the light shield plate 54 other than the slit 54a. The slit 54a is formed to extend along the Y-axis direction and allows passage of the laser beam from the optical system 20. The length of the slit 54a as measured along the Y-axis direction is set to a value slightly greater than the diameter of the recording area MP of the optical disc DK.

A radiation-energy-distribution detector 55 is disposed on the bottom surface of the depression 41e. The radiation-energy-distribution detector 55 is formed to extend along the Y-axis direction. The radiation-energy-distribution detector 55 is composed of a plate 55a, which extends along the Y-axis direction and is fixed to the bottom surface of the depression 41e; and a plurality of photo sensors 55b, 55c, 55d, etc., which are arranged along the Y-axis direction and fixed to the plate 55a. Each of the photo sensors 55b, 55c, 55d, etc. detects light quantity at the corresponding position and outputs to a radiation-energy-distribution measurement unit 57 a detection signal indicative of the detected light quantity. The radiation-energy-distribution measurement unit 57 determines, on the basis of the detection signals from the photo sensors 55b, 55c, 55d, etc., the intensity distribution of radiation energy (light quantity) in the laser beam emitted from the optical system 20, as measured at the respective Y-axis positions, and displays the detection results. In the present embodiment, a knife edge method is used for detection of radiation intensity distribution. In the knife edge method, the detection signals from the photo sensors 55b, 55c, 55d, etc. are differentiated so as to obtain corresponding differential profiles, on the basis of which suitability of light quantity is judged.

Here, the optical disc DK will be described further. As shown in FIG. 12, the optical disc DK is formed in an annular shape to have a circular through-hole at a central portion thereof. An annular center hub portion CP having a predetermined width Lc is provided on the radially outward side of the through-hole (i.e., the center hub portion CP is a portion on the radially inward side of the recording area MP). The center hub portion CP is formed of resin only, and therefore has low thermal conductivity. Accordingly, when heat is applied to the center hub portion CP, the center hub portion CP is likely to deform, and cracks are likely to be generated. On the radially outward side of the center hub portion CP, the recording area MP having a predetermined width Lm is formed integrally with the center hub portion CP.

The surface of the recording area MP is covered with a resin layer through molding or coating. Under the resin layer, a reflection layer, a dielectric layer, a phase-change-type recording layer, etc. are formed to thereby constitute a layered structure. The recording area MP has high thermal conductivity, by virtue of the presence of a metal film layer such as the reflection layer. Therefore, the recording area MP neither deforms nor generates cracks even when the temperature increases in response to irradiation with a laser beam. When the recording layer is heated to a temperature between the crystallization temperature and the melting point and is then gradually cooled, the recording area MP is crystallized uniformly. As a result, the optical disc DK (the recording area MP) is initialized. Therefore, the radiation energy of the light source 10 is set such that the recording layer is heated to a temperature between the crystallization temperature and the melting point.

In the optical disc DK, data are recorded on the recording area MP through an operation of heating a selected portion of the recording layer to a temperature higher than the melting point, and then cooling the selected portion quickly to thereby render the selected portion of the recording layer amorphous. Reading of data is performed on the basis of difference in reflectance between the crystallized portion and the portion that has been rendered amorphous.

Next, a detailed description will be given of a method of initializing an optical disc by use of the optical disc initialization apparatus having the above-described structure.

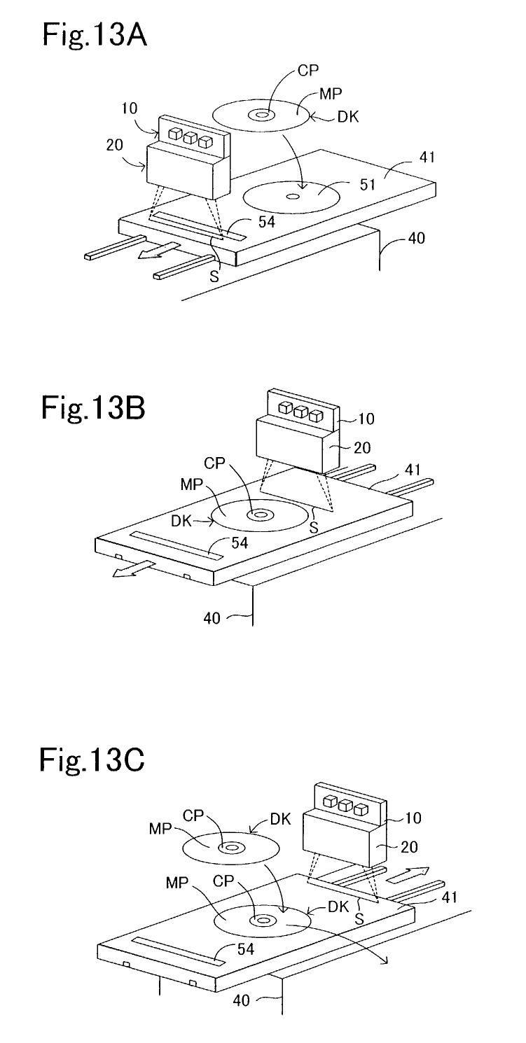

First, an operator performs initial setting for the optical disc initialization apparatus. During the initial setting, the drive units 30A, 30B, and 30C are operated, so that a laser beam is emitted from the light source 10, and a laser spot S is formed on the table 41 by means of the optical system 20. Subsequently, the table 41 is moved in a direction opposite that of an arrow in FIG. 13A to a position at which the laser beam passes through the slit 54a of the light shield plate 54. Notably, the table 41 is assumed to be located at a position shown in FIG. 9 before formation of the laser spot S. The movement of the table 41 is stopped at a position shown in FIG. 13A. In this state, if necessary, the drive units 30A, 30B, and 30C are adjusted in such a manner that the laser beam is radiated without variation along the Y-axis direction.

For the movement of the table 41, the drive control unit 44 and the position detection unit 46 are operated. As a result, the position detection unit 46 supplies to the drive control unit 44 a position detection signal indicative of the X-axis position of the table 41 relative to the base 40, which is detected by the position sensor 45. The drive control unit 44 controls rotation of the motor 43 on the basis of the position detection signal. Rotation of the motor 43 is transmitted to the pinion gear 42 so as to rotate the same. In response to rotation of the pinion gear 42, the table 41 is moved along the X-axis direction via the rack gear 41b. When the table 41 has been moved to the position of FIG. 13A, the drive control unit 44 stops the rotation of the motor 43. At this time, the drive units 30A, 30B, and 30C and the radiation-energy-distribution measurement unit 57 are each maintained in an operated state; and the laser beam is caused to radiate the radiation-energy-distribution detector 55 via the slit 54a.

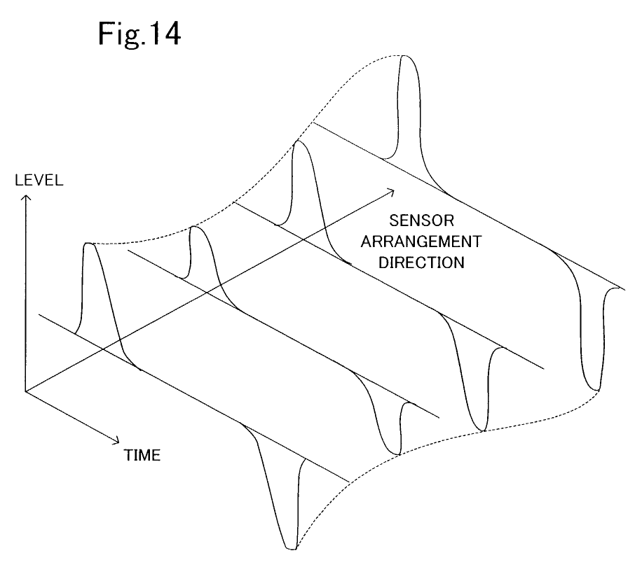

The radiation-energy-distribution measurement unit 57 processes, by means of differential processing; i.e., the knife edge method, the respective signals received from the photo sensors 55b, 55c, 55d, etc. of the radiation-energy-distribution detector 55 and representing respective light quantities, and displays the peak values of the light quantities detected by the photo sensors 55b, 55c, 55d, etc. (see FIG. 14). The operator adjusts the drive units 30A, 30B, and 30C, except for the case in which the peak values of the light quantities detected by the photo sensors 55b, 55c, 55d, etc. are constant, and therefore, the laser beam is judged to be radiated without variation along the Y-axis direction.

Specifically, when, as indicated by a broken line in FIG. 14, the peak values of the light quantities detected by the photo sensors 55b, 55c, 55d, etc. are not constant, the drive units 30A, 30B, and 30C are selectively adjusted so as to increase the output energies (light quantities) of laser beams emitted from the emitters 12a, 12b, 12c, etc. of the semiconductor laser arrays 12A, 12B, and 12C associated with low peak values. Further, the drive units 30A, 30B, and 30C are selectively adjusted so as to lower the output energies (light quantities) of laser beams emitted from the emitters 12a, 12b, 12c, etc. of the semiconductor laser arrays 12A, 12B, and 12C associated with high peak values. While adjusting the drive units 30A, 30B, and 30C, the operator desirably confirms that the peak values of the light quantities detected by the photo sensors 55b, 55c, 55d, etc. are constant, and therefore the laser beam is radiated without variation along the Y-axis direction, while reciprocating the table 41 over short distances from the position of FIG. 13A.

Notably, the drive units 30A, 30B, and 30C may be adjusted automatically in accordance with the peak values detected by the radiation-energy-distribution measurement unit 57. In this case, as indicated by a broken line in FIG. 9, signals indicative of respective peak values output from the radiation-energy-distribution measurement unit 57 are fed to the drive units 30A, 30B, and 30C; and the drive units 30A, 30B, and 30C automatically change the output energies (light quantities) of the laser beams emitted from the semiconductor laser arrays 12A, 12B, and 12C of the light source 10, without requiring manual operation by the operator.

During the above-described initial setting, the operator desirably operates the tilt mechanism 47 in order to tilt the optical axis of the laser beam emitted from the light source 10 via the optical system 20 by a predetermined angle relative to the Z-axis direction in the X-axis direction.

Moreover, desirably, the light source 10 and the optical system 20 are supported on the base 40 via an unillustrated support member in such a manner that the light source 10 and the optical system 20 are movable along the Z-axis direction and are rotatable about the X-axis. The Z-axis position (vertical position) and the rotational position (about the X-axis) of the light source 10 and the optical system 20 are adjusted manually or by means of an actuator such as an electric motor. In this case, the Z-axis position and the rotational position of the light source 10 and the optical system 20 are adjusted in such a manner that the peak values of the light quantities detected by the photo sensors 55b, 55c, 55d, etc. each assume a desired constant value and that the respective light quantity widths (the widths of profiles determined by the knife edge method) each assume a desired constant value.

Next, an actual operation of initializing an optical disc DK will be described. First, the overall operation will be described roughly. After completion of the above-described initial setting, as shown in 13A, an operator places the optical disc DK on the plate 51 of the table 41. After placement of the optical disc DK, the operator operates the pump 53 in order to evacuate air from the vacuum chamber 41g below the plate 51. As a result, the optical disc DK is fixed securely to the plate 51.

Subsequently, the operator moves the table 41 toward the direction indicated by the arrow in FIG. 13A. During this movement, as described above, the drive control unit 44 receives the position detection signal from the position detection unit 46 and controls the operation of the motor 43 on the basis of the position detection signal. Further, the drive control unit 44 controls the motor 43 to rotate at a predetermined constant velocity on the basis of the angular velocity of the motor 43, which is calculated by use of the signal output from the encoder 43a and indicates rotation of the motor 43. Rotation of the motor 43 is transmitted to the pinion gear 42, so that the table 41 moves toward the direction indicated by the arrow in FIG. 13A through actions of the pinion gear 42 and the rack gear 41b.

During the movement of the table 41, as shown in FIG. 13B, the optical disc DK is linearly scanned by the laser spot S of the laser beam emitted from the light source 10 via the optical system 20 and is thus initialized. That is, the recording layer at the recording area MP of the optical disc DK is crystallized uniformly, whereby the optical disc DK is initialized.

When the table 41 is moved to the position shown in FIG. 13C after completion of scanning of the optical disc DK by the laser beam, the drive control unit 44 stops operation of the motor 43. Accordingly, movement of the table 41 is also stopped. In this state, operation of the pump 53 is stopped in order to increase the air pressure within the vacuum chamber 41g. Subsequently, the operator removes the optical disc DK from the plate 51 of the table 41. When the air pressure within the vacuum chamber 41g is not very low, the operation of the pump 53 is not required to be stopped.

In the state shown in FIG. 13C, the operator places a new optical disc DK on the plate 51 of the table 41. As in the above-described case, after placement of the optical disc DK, the operator operates the pump 53 in order to reduce the air pressure within the vacuum chamber 41g, to thereby fix the optical disc DK to the table 41. Subsequently, the operator operates the drive control unit 44 again in order to move the table 41 by means of rotation of the motor 43. However, in this case, the motor 43 is rotated in the reverse direction in order to move the table 41 toward the direction indicated by an arrow in FIG. 13C. When the table 41 has moved to the position of FIG. 13A, the drive control unit 44 stops rotation of the motor 43 in order to stop the table 41. In this state, the operator stops operation of the pump 53, as in the above-described case, in order to increase the air pressure within the vacuum chamber 41g; and removes the optical disc DK from the plate 51 of the table 41.

Further, the operator places a new optical disc DK on the plate 51 of the table 41 in the state shown in FIG. 13A, and repeats the above-described operation. As described above, optical discs DK are initialized successively through repetition of the operation of placing an optical disc DK on the plate 51 of the table 41 and removing the optical disc DK from the plate 51 after completion of initialization thereof, while moving the table 41 back and forth. Since each optical disc DK is initialized by means of a single linear scanning of the laser spot S, initialization of each optical disc DK can be performed efficiently within a shortened period of time. In addition, since two optical discs DK can be initialized by means of a single cycle of the table reciprocation 41, initialization of optical discs DK can be performed with considerable efficiency.

During such a series of operations, the radiation-energy-distribution measurement unit 57 detects and displays the peak values of the light quantities detected by the photo sensors 55b, 55c, 55d, etc. of the radiation-energy-distribution detector 55. Therefore, even during such a series of operations, when the light quantities detected by the photo sensors 55b, 55c, 55d, etc. have failed to attain constant peak values, and the laser beam has been judged to be radiated with variation along the Y-axis direction, the drive units 30A, 30B, and 30C can be adjusted manually or automatically in order to attain uniform radiation. Moreover, when uniform radiation cannot be obtained for reasons of breakdown of any of the drive units 30A, 30B, and 30C, or the semiconductor laser arrays 12A, 12B, and 12C of the light source 10, the above-described series of initialization operations is stopped. This operation is advantageous, because initialization of optical discs DK can be performed uniformly at all times.

In the above description, during the series of operations for initializing optical discs DK, operation of the drive control unit 44 (the motor 43) and operation of the pump 53 are started and stopped by means of operator's manual operation. However, these start/stop controls may be performed automatically on the basis of the position detection signal from the position detection unit 46. In this case, all the operations of the drive control unit 44 (the motor 43) and the pump 53 are subjected to automatic sequence control, so that the operator is required to perform only an operation of loading an optical disc DK onto the table 41 and removing the same from the table 41.

In the case in which such automatic sequence control is performed, preferably, a placement sensor 58 is provided on the plate 51 of the table 41, as indicated by a broken line in FIG. 9, in order to detect whether an optical disc DK is placed on the plate 51; and a detection signal output from the placement sensor 58 is utilized. A sensor which utilizes reflection of light or ultrasonic waves can be used as the placement sensor 58.

The sequence control performed by use of the placement sensor 58 will now be described. The motor 43 and the pump 53 are stopped until placement of an optical disc DK on the plate 51 is detected. In response to detection of placement of an optical disc DK on the plate 51, the pump 53 is operated in order to fix the optical disc DK to the plate 51, and the motor 43 is operated in order to move the table 41. After completion of initialization of the optical disc DK, the motor 43 is stopped on the basis of the position detection signal, and the pump 53 is stopped. The stop control for the pump 53 may be omitted when the force of attracting the optical disc DK by means of the pump 53 and the vacuum chamber 41g is not very large.

The initialization apparatus may be modified to automatically load an optical disc DK onto the plate 51 of the table 41 in synchronism with reciprocation motion of the table 41. In this case, an arm capable of holding an optical disc DK is provided. The arm is controlled to hold an optical disc DK, move the optical disc DK to a location above the plate 51, and release the optical disc DK. After initialization, the arm is controlled to hold the optical disc DK placed on the plate 51, andremoveitfromtheplate51. Holding and releasing operations of the arm and movement of the arm are interlocked with movement of the table 41.

During the reciprocation motion of the table 41, the rotational velocity of the motor 43 is controlled to a constant velocity by means of the drive control unit 44. On the basis of the rotational velocity of the motor 43 calculated from the output signal from the encoder 43a built into the motor 43, the drive control unit 44 controls the motor 43 in such a manner that the motor 43 rotates at a constant velocity at all times. By virtue of this control, the optical disc DK can be initialized homogeneously along the X-axis direction.

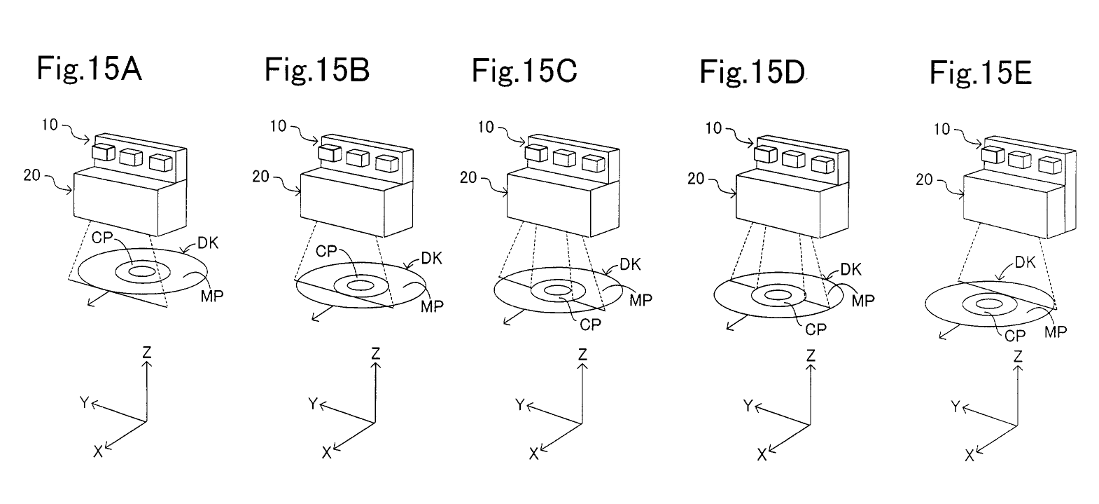

Moreover, during the reciprocation motion of the table 41, the drive units 30A, 30B, and 30C individually control the output energies (light quantities) of the laser beams emitted from the semiconductor laser arrays 12A, 12B, and 12C of the light source 10, on the basis of the position detection signal output from the position detection unit 46. Next, this control will be described specifically. On the basis of the position detection signal output from the position detection unit 46, the drive units 30A, 30B, and 30C maintain the light source 10 in a stopped state up to a point immediately before an optical disc DK reaches the laser spot S formed by the light source 10 and the optical system 20, as shown in FIG. 15A.

When the laser spot S comes close to the edge of the optical disc DK, the drive units 30A, 30B, and 30C operate the semiconductor laser arrays 12A, 12B, and 12C, respectively and control the output energies (light quantities) of the laser beams emitted from the semiconductor laser arrays 12A, 12B, and 12C in such a manner that the radiation intensity within the laser spot S becomes uniform along the Y-axis direction. This state is maintained up to a point immediately before the edge of the annular center hub portion CP of the optical disc DK reaches the laser spot S, as shown in FIG. 15B.

When the center hub portion CP of the optical disc DK passes through the laser spot S, as shown in FIGS. 15C and 15D, the radiation intensity (light quantity) within the laser spot S is lowered at a central portion with respect to the Y-axis direction in order to prevent, to the extent possible, irradiation of the center hub portion CP of the disc DK with the laser beam. Specifically, the drive units 30A and 30C set and control the semiconductor laser arrays 12A and 12C located at opposite ends in the same manner as described above. However, the drive unit 30B sets and controls the centrally positioned semiconductor laser array 12B, on the basis of the position detection signal from the position detection unit 46, in order to lower the radiation intensity (light quantity) of the laser beam output from the semiconductor laser array 12B.

In this case, when the number of the semiconductor laser arrays and the number of the drive units corresponding thereto are increased as described above, the intensity distribution of radiation energy (light quantity) within the laser spot S along the Y-axis direction can be changed finely. When the radiation energies (light quantities) of laser beams emitted from a plurality of semiconductor laser arrays located at a central portion are controlled individually on the basis of the position detection signal, the intensity distribution of radiation energy (light quantity) within the laser spot S along the Y-axis direction can be controlled in such a manner that the radiation intensity is increased in a region from the outer circumference of the center hub portion CP to the outer circumference of the optical disc DK; i.e., at the recording area MP, and is decreased at the center hub portion CP. By virtue of this operation, temperature increase in the center hub portion CP upon irradiation of a laser beam can be avoided, and thus, generation of cracks in the center hub portion CP can be prevented.

When the laser spot S has passed through the optical disc DK, the drive units 30A, 30B, and 30C stop the operations of the semiconductor laser arrays 12A, 12B, and 12C of the light source 10, respectively. In the above-described embodiment, when the laser spot S passes through the optical disc DK, the upper surface of the table 41 located outside the optical disc DK is irradiated with the laser beam, together with the recording area MP of the optical disc DK. However, the initialization apparatus may be modified so as to reduce the radiation intensity imparted to the upper surface of the table 41 located outside the optical disc DK. Specifically, as in the case of the center hub portion CP, the drive units 30A, 30B, and 30C control the output energies of the semiconductor laser arrays 12A, 12B, and 12C of the light source 10, respectively, on the basis of the position detection signal from the position detection unit 46, in order to reduce the radiation intensity on the outer side of the optical disc DK.

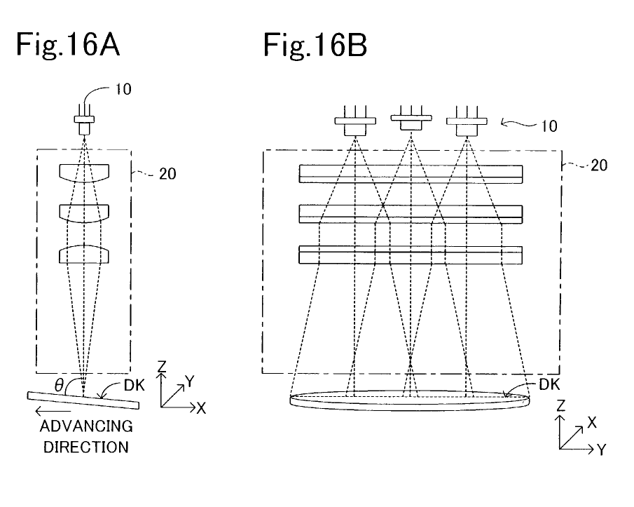

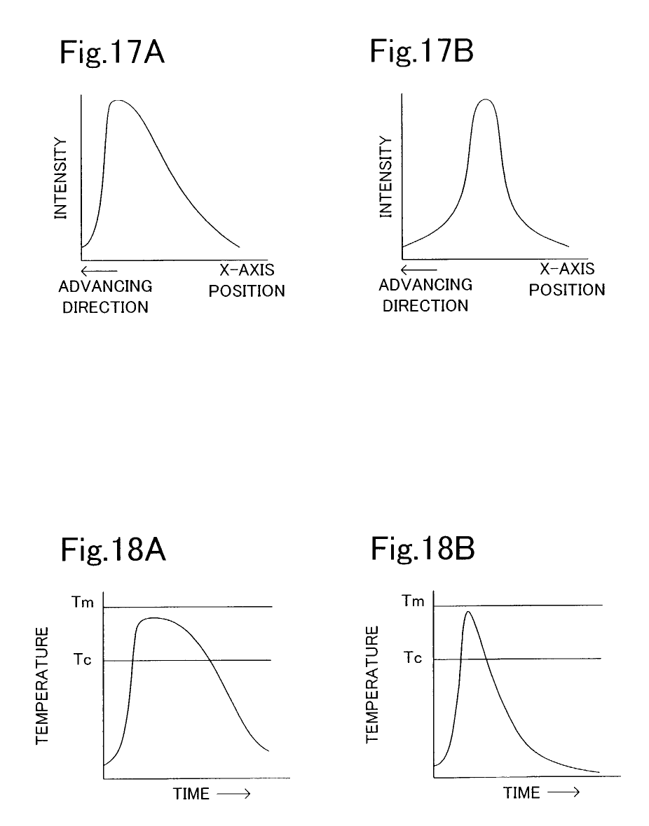

Next, there will be described the effect attained by tilting, relative to the Z-axis direction, the optical axis of the laser beam emitted from the light source 10 and the optical system 20 by a desired angle along the X-axis direction (the direction of the minor axis of the laser spot S formed by the laser beam). FIGS. 16A and 16B show a state in which the optical axis of the laser beam is tilted by a small angle from the vertical position toward the advancing direction of the laser spot S. By virtue of this tilting, as shown in FIG. 17A, the peak of a intensity distribution of radiation energy (light quantity) of a laser beam; i.e., the peak of a distribution of intensity of the laser beam as measured on the optical disc DK, is shifted toward the advancing direction of the laser spot S along the X-axis direction. By contrast, FIG. 17B shows a distribution of intensity of the laser beam, as measured on the optical disc DK for the case in which the optical axis of the laser beam is set to be perpendicular to the optical disc DK (parallel to the Z-axis direction). In this case, the intensity profile becomes symmetrical with respect to the peak position in accordance with the Gaussian distribution.

When the optical disc DK is moved along the X-axis direction while the laser beam is radiated onto the optical disc DK, the temperature of a portion of the optical disc DK irradiated with the laser beam changes with time as shown in FIG. 18A. Specifically, upon passage of the laser beam whose intensity profile has a peak shifted toward the advancing direction as shown in FIG. 17A, the recording layer of the recording area MP of the optical disc DK is quickly heated to a temperature between the crystallization temperature Tc and the melting point Tm, and then cooled slowly. The purpose of heating the recording layer of the recording area MP to a temperature between the crystallization temperature Tc and the melting point Tm is to uniformly recrystallize the recording layer for initialization. This is realized through setting of the output energies (light quantities) of the semiconductor laser arrays 12A, 12B, and 12C of the laser light source 10.

By contrast, when the laser beam is radiated onto the optical disc DK perpendicular thereto and the laser beam has an intensity profile as shown in FIG. 17B, immediately after passage of the peak of the intensity, the recording layer of the recording area MP of the optical disc DK is quickly heated to a temperature between the crystallization temperature Tc and the melting point Tm, and then cooled quickly (see FIG. 18B). As is understood from the above, when the optical axis of the laser beam is tilted toward the advancing direction of the optical disc DK as in the above-described embodiment, the heat radiation time after the temperature elevation of the recording layer of the recording area MP can be extended, so that the recording layer of the optical disc DK can be crystallized densely.

In the case in which the direction of movement of an optical disc DK relative to the laser beam is switched upon completion of each initialization operation as in the above-described embodiment, the tilt direction of the optical system 20 must be switched in accordance with the advancing direction of each optical disc DK, through control of the tilt mechanism 47.

The above-described embodiment may be modified in such a manner that the drive units 30A, 30B, and 30C are controlled in accordance with the relative velocity of the table 41 relative to the base 40. In this case, as indicated by a broken line in FIG. 9, an additional control signal is supplied to the drive units 30A, 30B, and 30C. The magnitude of the control signal increases with the angular velocity of the motor 43, which the drive control unit 44 calculates on the basis of the detection signal from the encoder 43a; i.e., the velocity of the table 41 relative to the base 40. The drive units 30A, 30B, and 30C perform proportional control for the semiconductor laser arrays 12A, 12B, and 12C in such a manner that the output energies (light quantities) of the respective laser beams increase with the relative velocity.

Moreover, in place of the angular velocity calculated by means of the drive control unit 44, there may be used a relative velocity calculated by means of a relative velocity detection circuit which may be provided in the position detection unit 46 in order to differentiate the position detection signal to thereby obtain the relative velocity of the table 41 relative to the base 40. In this case as well, the drive units 30A, 30B, and 30C perform proportional control for the semiconductor laser arrays 12A, 12B, and 12C in such a manner that the output energies (light quantities) of the respective laser beams increase with the calculated relative velocity. Further, when the relative velocity detection circuit is provided in the position detection unit 46 as described above, in place of the angular velocity of the motor 43 calculated by means of the drive control unit 44, a detection signal indicative of the relative velocity calculated by means of the relative velocity detection circuit may be supplied to the drive control unit 44, which may be configured to control the rotational velocity of the motor 43 in accordance with the calculated relative velocity.

By virtue of the above-described configuration, the energy (light quantity) of the laser beam radiated onto an optical disc DK increases in proportion to the velocity at which the laser spot S scans the optical disc DK. Accordingly, the temperature increase of the recording area MP of the optical disc DK upon laser irradiation is controlled at a substantially constant level irrespective of variation in the relative velocity between the table 41 and the base 40. As a result, the optical disc DK is initialized homogeneously at all times irrespective of variation in the relative velocity.

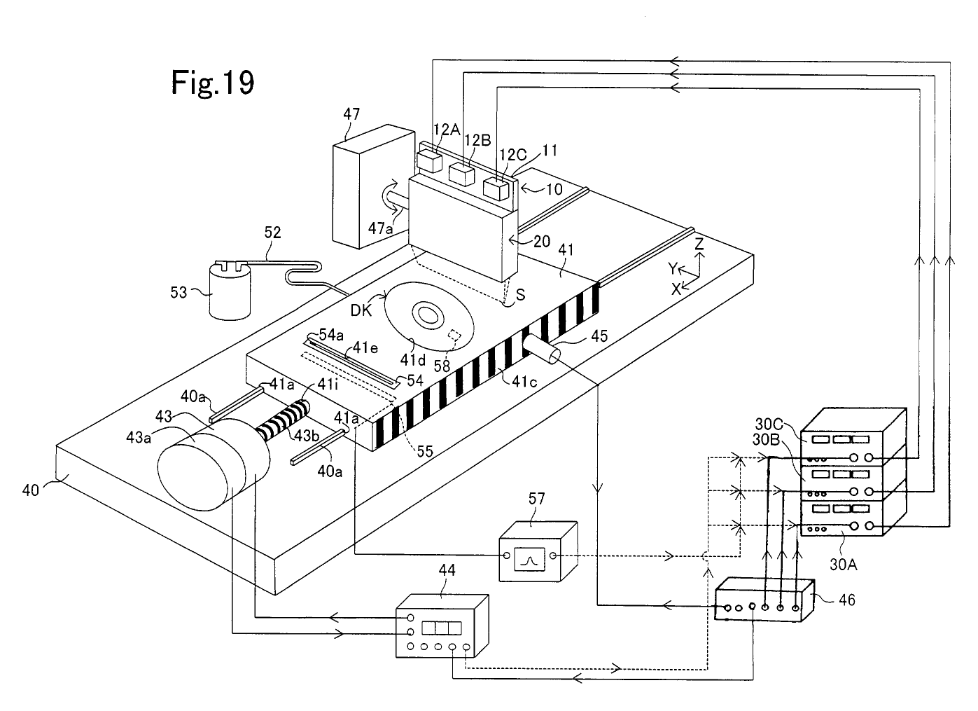

Next, various modifications of the above-described embodiment will be described. In the above-described embodiment, a rack-and-pinion mechanism composed of the rack gear 41b and the pinion gear 42 is employed as a mechanism for moving the table 41 relative to the base 40 along the X-axis direction. However, the table 41 may be moved relative to the base 40 along the X-axis direction by use of a ball screw mechanism. Specifically, as shown in FIG. 19, a ball screw 43b, which rotates together with the rotary shaft of the motor 43, is provided in such a manner that the ball screw 43b extends toward the interior of the table 41 from the front end face thereof. A female thread 41i is formed on the table 41 side and is in meshing engagement with the ball screw 43b. By virtue of this configuration, as in the case of the above-described embodiment, the table 41 is moved along the X-axis direction through control of rotation of the motor 43 by means of the drive control unit 44, so that the initialization apparatus of the present modification operates in the same manner as in the above-described embodiment.

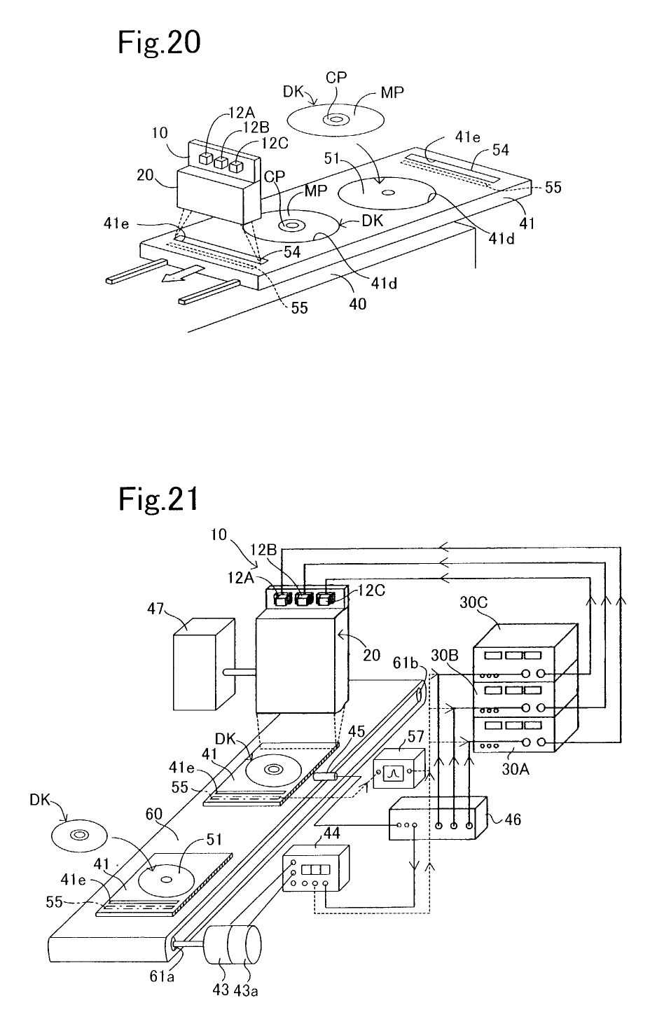

In the above-described embodiment, only one optical disc DK is placed on the table 41; and the table 41 is moved back and forth. However, as shown in FIG. 20, a plurality of (e.g., two) depressions 41d each accommodating a plate 51 may be provided on the table 41; and a plurality of (e.g., two) optical discs DK may be initialized by means of single one-way stroke of the table 41. In this case, a depression 41e is provided for each of the plates 51, and a radiation-energy-distribution detector 55 is accommodated within each depression 41e such that the detector 55 extends along the Y-axis direction. This enables the Y-axis energy intensity distribution of the laser beam to be checked each time initialization of a single optical disc DK is completed.

In the above-described embodiment and the modifications shown in FIGS. 19 and 20, respectively, optical disc initialization is performed during each of the forward and backward movements of the table 41. However, optical disc initialization may be performed during a selected one of the forward and backward movements of the table 41. Specifically, after placement of an optical disc DK on the plate 51 of the table 41, the table 41 is moved in one direction, while a laser beam is radiated on the table 41 (the optical disc DK) by means of the light source 10 and the optical system 20. After completion of the initialization, the optical disc DK is removed from the table 41. Subsequently, after the irradiation of the laser beam is stopped, the table 41 is moved in the opposite direction to the initial position.

Through repetition of the above-described operation, a plurality of optical discs DK can be initialized successively and efficiently. In this case, since the direction of movement of each optical disc DK relative to the laser spot S is the same at all times, the tilt direction of the optical axis of the laser beam relative to the Z-axis direction is not required to change. As a result, in this modification, the inclination of the light source 10 and the optical system 20 set by means of the tilt mechanism 47 is not required to change from the initially set inclination. This obviates the necessity of operating the tilt mechanism 47 so as to change the inclination of the light source 10 and the optical system 20 during the operation of initialization of a plurality of optical discs DK.

In the case in which the table 41 is moved back and forth as in the above-described embodiment and the modifications shown in FIGS. 19 and 20, an optical disc DK may be initialized by means of straight movement of the light source 10 and the optical system 20, without movement of the table 41. In this case, the position sensor 45 and the position detection unit 46 detect the X-axis position of the light source 10 and the optical system 20 relative to the table 41; and on the basis of the detected X-axis position, the drive control unit 44 and the motor 43 move the light source 10 and the optical system 20 relative to the table 41 via an unillustrated power transmission mechanism. Further, in the present modification, the tilt mechanism 47 is also moved together with the optical system 20.

In this case as well, the drive units 30A, 30B, and 30C individually control the output energies (light quantities) of laser beams from the semiconductor laser arrays 12A, 12B, and 12C on the basis of the detected X-axis position in the same manner as described above. Specifically, during the movement of the light source 10 and the optical system 20, the semiconductor laser arrays 12A, 12B, and 12C are adjusted and controlled in such a manner that sufficient radiation intensity (light quantity) is imparted to the recording layer of the recording area MP of each optical disc DK, while the radiation intensity imparted to the center hub portion CP of the optical disc DK is minimized.

As a result, even in the present modification, each optical disc DK can be initialized efficiently as in the case of the above-described embodiment; and generation of cracks in the center hub portion CP of the optical disc DK can be avoided. In the present modification as well, like the above-described embodiment, the radiation intensity of the laser beam at the laser spot S is preferably controlled in accordance with a velocity at which the optical disc DK passes through the laser spot S. In this case, the optical disc DK can be uniformly initialized, irrespective of the velocity of the light source 10 and the optical system 20.

In the above-described embodiment, the table 41 is moved back and forth. However, the table 41 may be moved continuously in one direction only. In this case, as shown in FIG.21, a conveyer 60, which is rotated and driven by the motor 43, is provided. The conveyer 60 is constituted by a flexible continuous sheet formed into a looped shape. The conveyer 60 is supported by rotary shafts 61a and 61b disposed inside the conveyer 60 to be located at the opposite ends thereof. Thus, the conveyer 60 can travel along its longitudinal direction. The rotary shafts 61a and 61b are rotatably supported on unillustrated stationary members. One rotary shaft 61a is connected to the rotary shaft of the motor 43. A plurality of tables 41 are fixed to the conveyer 60 at appropriate positions. In order to allow each table 41 to move together with the conveyer 60 even when the table 41 approaches the rotary shaft 61a or 61b, the table 41 is fixed to the conveyer 60 at an appropriately selected position of the table 41.

In the present modification, the operator places an optical disc DK on the plate 51 of a table 41 before the table 41 reaches the laser spot S. Subsequently, after the optical disc DK has been passed below the light source 10 and the optical system 20 and initialized, the operator removes the optical disc DK from the plate 51. Therefore, even in the present modification, a plurality of optical discs DK are initialized successively and efficiently. In the present modification as well, the radiation intensity of the laser beam at the laser spot S is preferably controlled in accordance with a velocity at which the optical disc DK passes through the laser spot S.

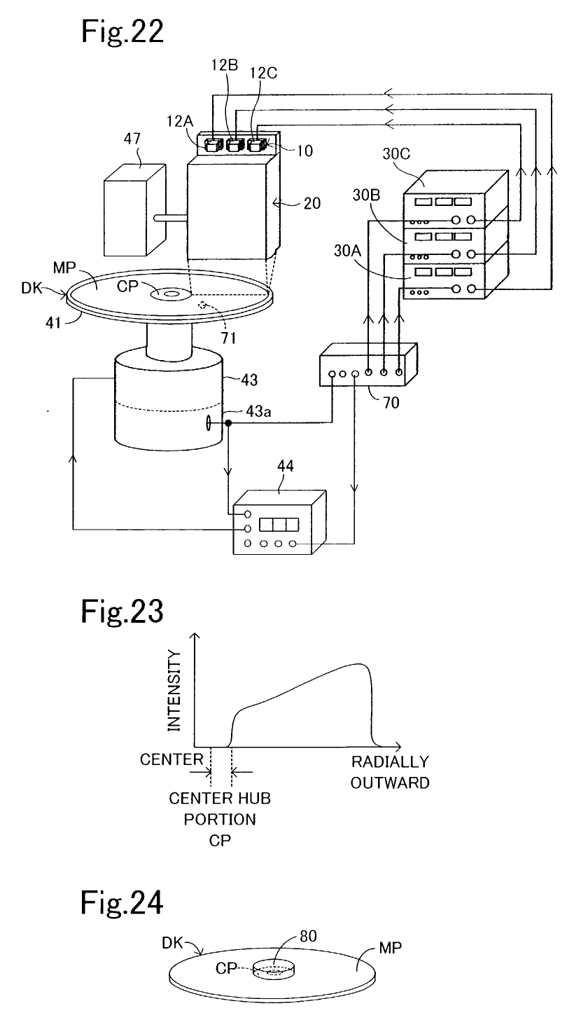

In the above-described embodiment and various modifications thereof, each optical disc DK is initialized through an operation of causing the laser beam to linearly scan the optical disc DK. However, as shown in FIG. 22, each optical disc DK can be initialized through an operation of causing the laser beam to scan the optical disc DK along its circumferential direction.

Specifically, the table 41 is configured to be rotated by the motor 43; and an optical disc DK is fixedly placed on the table 41. The light source 10 and the optical system 20 are configured in such a manner that the width (the length of an elliptical spot S along the major axis thereof) of a laser beam radiated on the optical disc DK is set to a value slightly greater than the width in the radial direction of the recording area MP of the optical disc DK. The light source 10 and the optical system 20 are fixedly disposed on an unillustrated stationary member. In the present embodiment as well, the output energies (light quantities) of laser beams from the semiconductor laser arrays 12A, 12B, and 12C are individually adjusted by the drive units 30A, 30B, and 30C.

Since the linear velocity of the optical disc DK decreases toward the radially inward side thereof, the basic adjustment for the output energies (light quantities) of the laser beams is performed in such a manner that, as shown in FIG. 23, the radiation intensity (light quantity) within the radiation spot S on the optical disc DK decreases toward the radially inward side of the optical disc DK. Specifically, in the example shown in FIG. 22, the output energy (light quantity) of the laser beam output from the semiconductor laser array 12A is decreased; and the output energy (light quantity) of the laser beam output from the semiconductor laser array 12C is increased. In this case as well, the number of the semiconductor laser arrays and the number of the drive units are preferably increased to a number (e.g., about 8) greater than 3. This enables the radiation intensity (light quantity) of the laser beam radiated on the optical disc DK can be decreased gradually from the radially outward side toward the radially inward side of the optical disc DK.

In the present modification, in place of the position detection unit 46, a rotation detection unit 70 is provided. The rotation detection unit 70 includes an angular velocity detection circuit and a rotational position detection circuit. The angular velocity detection circuit receives from the encoder 43a built in the motor 43 a signal indicative of rotation of the motor 43 (e.g., the signal consisting of two phase signals which have a phase shift of π/4 therebetween and represent rotation of the rotor relative to the stator), calculates angular velocity of the table 41, and outputs an angular velocity signal indicative of the calculated angular velocity. The rotational position detection circuit receives from the encoder 43a a signal indicative of rotation of the motor 43 (e.g., the two phase signals and a signal indicating that the rotor is located at a reference rotational position relative to the stator), calculates rotational position (rotational angle) of the table 41 relative to a reference rotational position, and outputs a rotational position signal indicative of the calculated rotational position.

The rotational position signal output from the rotation detection unit 70 is supplied to the drive control unit 44. On the basis of the rotational position signal, the drive control unit 44 controls start and stop of operation of the motor 43 in order to rotate the table 41 (i.e., the optical disc DK placed on the table 41) one turn and then stop the table 41. Moreover, as in the case of the above-described embodiment, the drive control unit 44 controls the motor 43 to rotate at a constant rotational velocity, on the basis of the angular velocity calculated from the signal output from the encoder 43a and indicating rotation of the motor 43. As to control of rotational velocity of the motor 43, the drive control unit 44 may receive the angular velocity signal output from the rotation detection unit 70 and control the rotational velocity of the motor 43 on the basis of the received angular velocity signal.

The rotational position signal and angular velocity signal output from the rotation detection unit 70 are supplied to the drive units 30A, 30B, and 30C as well. On the basis of the rotational position signal, the drive units 30A, 30B, and 30C control start and stop of operations of the semiconductor laser arrays 12A, 12B, and 12C of the light source 10 in synchronism with start and stop of rotation of the motor 43. In addition, the drive units 30A, 30B, and 30C individually control the output energies (light quantities) of the laser beams emitted from the semiconductor laser arrays 12A, 12B, and 12C in such a manner that the output energies (light quantities) decrease as the angular velocity of the table 41 decreases. This control is unnecessary in the case in which the motor 43 rotates at a constant angular velocity at all times. However, in actuality, such control is necessary because, in some periods, the motor 43 does not rotate at the constant angular velocity even when under the control by the drive control unit 44. Notably, as in the above-described cases, the tilt mechanism 47 for tilting the optical system 20 from a direction perpendicular to the table 41 (an optical disc DK) toward the advancing direction of the optical disc DK is provided.

Next, a detailed description will be given of a method of initializing an optical disc by use of a rotary-type optical disc initialization apparatus having the above-described structure. After placement and fixation of an optical disc DK on thetable41, the operator operates the motor 43 by manipulating the drive control unit 44, to thereby rotate the optical disc DK at a position under the light source 10 and the optical system 20. In this case, the drive control unit 44 rotates the motor 43 at an angular velocity which is constant to a possible extent.

When the rotational position signal from the output from the rotation detection unit 70 indicates that the table 41 is located at the reference rotational position, the drive units 30A, 30B, and 30C start the semiconductor laser arrays 12A, 12B, and 12C, respectively. As a result, a laser spot S is formed on the recording area MP of the optical disc DK in such a manner that the major axis of the spot S extends in a radial direction. As the optical disc DK rotates, the recording area MP is scanned by the laser beam. When the optical disc DK has rotated one turn and the rotational position signal from the output from the rotation detection unit 70 indicates again that the table 41 is located at the reference rotational position, the drive units 30A, 30B, and 30C stop the operations of the semiconductor laser arrays 12A, 12B, and 12C, respectively.

The rotational position signal is supplied to the drive control unit 44 as well. In response to this signal, the drive control unit 44 stops rotation of the motor 43. In this manner, the entire recording area MP of the optical disc DK is initialized upon rotation of the optical disc DK over substantially one turn. Subsequently, the operator fixedly places a new optical disc DK on the table 41, and starts the motor 43 by manipulating the drive control unit 44, whereby the new optical disc DK is initialized. Accordingly, even when the initialization apparatus of the present modification is used, a plurality of optical discs DK can be initialized successively and efficiently.

During the above-described optical disc initialization operation, the laser beam from the light source 10 and the optical system 20 is radiated onto the recording area MP of the optical disc DK only, and is not radiated onto the center hub portion CP of the optical disc DK. Therefore, the temperature of the center hub portion CP does not increase upon radiation of the laser beam, and generation of cracks in the center hub portion CP can be avoided. Moreover, in the initialization apparatus of the present modification, by the action of the drive units 30A, 30B, and 30C, the radiation intensity (light quantity) of the laser beam is reduced at a portion at which the linear velocity decreases. Therefore, the recording area MP can be initialized uniformly. In addition, since the optical disc DK is rotated in a single direction, the operation of tilting the optical system 20 by means of the tilt mechanism 47 is required to be performed at the beginning only.

The above description premises that the operation of the drive control unit 44 (the motor 43) is started by means of a manual operation by the operator in order to perform a series of operations for initializing an optical disc DK. However, in the present modification as well, the operator's operation for the drive control unit 44 can be omitted in the case where a placement sensor 71 similar to the above-described placement sensor 58 is attached to the table 41 as indicated by a broken line in FIG. 22, so that the drive control unit 44 is controlled on the basis of a detection signal output from the placement sensor 71. In this case, when the placement sensor 71 detects that an optical disc DK has been placed on the table 41, the drive control unit 44 is controlled to start rotation of the motor 43.

Moreover, when an unillustrated arm for holding an optical disc DK is used as described above, the operator's labor for loading an optical disc DK on the table 41 can be eliminated.

In the modification of FIG. 22 as well, instead of rotating the table 41, the light source 10 and the optical system 20 may be rotated in order to initialize an optical disc DK. Specifically, the present modification may be modified to include a rotation drive mechanism for rotating the light source 10 and the optical system 20 about the center of the optical disc DK placed on the table 41, so that the laser beam moves in the circumferential direction along the recording area MP of the optical disc DK. As a result, even when the initialization apparatus of the present modification is used, the optical disc DK can be initialized efficiently.

In the above-described embodiment and various modifications thereof, as shown in FIG. 24, a circular protection cap 80 for shutting off the laser beam may be attached to an optical disc DK before initialization. Specifically, the protection cap 80 is formed of a resin or metal and has a diameter slightly greater than the diameter of the center hub portion CP so as to cover the center hub portion CP. After the protection cap 80 is attached to, or placed on, the center hub portion CP of the optical disc DK, the optical disc DK is initialized by the initialization apparatus shown in FIG. 9 and FIGS. 19 to 21.

Use of the protection cap 80 prevents irradiation of the center hub portion CP with the laser beam from the light source 10 and the optical system 20 and thus obviates the necessity of laser beam radiation control for avoiding the center hum portion CP. Notably, when use of the protection cap 80 is combined with the laser beam radiation control for avoiding the center hum portion CP, thermal damage to the center hum portion CP (generation of cracks) can be prevented more reliably.

Obviously, numerous modifications and variations of the present invention are possible in light of the above teachings. It is therefore to be understood that within the scope of the appended claims, the present invention maybe practiced otherwise than as specifically described herein.

What is claimed is:

1. An optical disc initialization apparatus in which a laser beam from a light source is radiated onto an optical disc via an optical system to thereby initialize the optical disc, wherein
the light source comprises a plurality of semiconductor laser arrays each having a plurality of emitters arranged in a row, the semiconductor laser arrays being disposed in such a manner that all the emitters among all the semiconductor laser arrays are arranged along the same direction.

2. An optical disc initialization apparatus according to claim 1, wherein the optical system forms a laser spot of an elongated elliptical shape on the optical disc.

3. An optical disc initialization apparatus according to claim 1, further comprising a plurality of drive units for individually controlling the plurality of semiconductor laser arrays in order to control the output energies of the emitters on an array-by-array basis.

4. An optical disc initialization apparatus comprising:
a table on which an optical disc is placed;
a light source including a plurality of emitters arranged in a row and each emitting a laser beam;
an optical system for introducing the laser beams from the light source and for forming on the optical disc an elongated laser spot having a length equal to or greater than a diameter of a recording area of the optical disc; and
a moving mechanism for driving the table or driving the light source and the optical system in order to move the table relative to the light source and the optical system along a direction parallel to an upper surface of the optical disc and perpendicular to the major axis of the laser spot, wherein the optical disc is initialized through linear scanning of the upper surface of the optical disc by means of the laser spot.

5. An optical disc initialization apparatus according to claim 4, further comprising:
a position detection unit for detecting relative position of the laser spot with respect to the optical disc, the position changing in accordance with relative movement of the table with respect to the light source and the optical system; and
a drive unit for controlling output energies of the plurality of emitters of the light source in accordance with the relative position detected by means of the position detection unit.

6. An optical disc initialization apparatus according to claim 5, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
the drive unit is individually provided for each of the plurality of semiconductor laser arrays in order to control the output energies of the emitters of the plurality of semiconductor laser arrays on an array-by-array basis.

7. An optical disc initialization apparatus according to claim 4, further comprising:
a velocity detection unit for detecting relative velocity of the table with respect to the light source and the optical system; and
a drive unit for controlling output energies of the plurality of emitters of the light source in accordance with the relative velocity detected by means of the velocity detection unit.

8. An optical disc initialization apparatus according to claim 7, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
the drive unit is individually provided for each of the plurality of semiconductor laser arrays in order to control the output energies of the emitters of the plurality of semiconductor laser arrays on an array-by-array basis.

9. An optical disc initialization apparatus according to claim 4, wherein the moving mechanism is configured to reciprocate the table relative to the light source and the optical system.

10. An optical disc initialization apparatus according to claim 4, further comprising an energy intensity distribution detection unit provided on the table and adapted to detect intensity distribution of radiation energy of the laser beam along the direction of the major axis of the laser spot.

11. An optical disc initialization apparatus according to claim 4, further comprising a tilt mechanism for tilting the optical axis of the laser beam from the light source and the optical system in a direction in which the table moves relative to the light source and the optical system.

12. An optical disc initialization apparatus comprising:
a table on which an optical disc is placed;
a light source including a plurality of emitters arranged in a row and each emitting a laser beam;
an optical system for introducing the laser beams from the light source and for forming an elongated laser spot on the optical disc, the elongated laser spot having a length equal to or greater than a radial width of a recording area of the optical disc, and having a major axis which extends radially with respect to the optical disc; and
a rotation mechanism for rotating the table or rotating the light source and the optical system in order to rotate the table relative to the light source and the optical system, wherein the optical disc is initialized through circumferential scanning of the upper surface of the optical disc by means of the laser spot.

13. An optical disc initialization apparatus according to claim 12, further comprising a drive unit for adjusting output energies of the plurality of emitters of the light source.

14. An optical disc initialization apparatus according to claim 13, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
the drive unit is individually provided for each of the plurality of semiconductor laser arrays in order to adjust the output energies of the emitters of the plurality of semiconductor laser arrays on an array-by-array basis.

15. An optical disc initialization apparatus according to claim 12, further comprising:
an angular velocity detection unit for detecting angular velocity of the table; and
a drive unit for controlling output energies of the plurality of emitters of the light source in accordance with the angular velocity detected by means of the angular velocity detection unit.

16. An optical disc initialization apparatus according to claim 15, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
the drive unit is individually provided for each of the plurality of semiconductor laser arrays in order to control the output energies of the emitters of the plurality of semiconductor laser arrays on an array-by-array basis.

17. An optical disc initialization apparatus according to claims 12, further comprising a tilt mechanism for tilting the optical axis of the laser beam from the light source and the optical system in a tangential direction of the optical disc.

18. An optical disc initialization method comprising:
providing a table on which an optical disc is placed, a light source including a plurality of emitters arranged in a row and each emitting a laser beam, and an optical system for introducing the laser beams from the light source and for forming on the optical disc an elongated laser spot having a length equal to or greater than a diameter of a recording area of the optical disc; and
driving the table or driving the light source and the optical system in order to move the table relative to the light source and the optical system along a direction parallel to an upper surface of the optical disc and perpendicular to the major axis of the laser spot, whereby the upper surface of the optical disc is linearly scanned for initialization by means of the laser spot.

19. An optical disc initialization method according to claim 18, further comprising:
detecting relative position of the laser spot with respect to the optical disc, the position changing in accordance with relative movement of the table with respect to the light source and the optical system; and
controlling output energies of the plurality of emitters of the light source in accordance with the detected relative position in order to reduce the radiation intensity of the laser beam at a portion located on the inward side of the recording area of the optical disc.

20. An optical disc initialization method according to claim 19, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
the output energies of the emitters of the plurality of semiconductor laser arrays are individually controlled on an array-by-array basis.

21. An optical disc initialization method according to claim 18, further comprising:
detecting relative velocity of the table with respect to the light source and the optical system; and
controlling output energies of the plurality of emitters of the light source in accordance with the detected relative velocity in order to increase the radiation intensity of the laser beam with the relative velocity.

22. An optical disc initialization method according to claim 21, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
control of output energies of the plurality of emitters of the light source is individually performed for each of the plurality of semiconductor laser arrays.

23. An optical disc initialization method according to claim 18, further comprising reciprocating the table relative to the light source and the optical system.

24. An optical disc initialization method according to claim 18, further comprising detecting intensity distribution of radiation energy of the laser beam along the direction of the major axis of the laser spot so as to check the state of radiation of the laser beam onto the optical disc.

25. An optical disc initialization method according to claim 18, further comprising tilting the optical axis of the laser beam from the light source and the optical system in a direction in which the table moves relative to the light source and the optical system, in order to radiate an inclined laser beam onto the optical disc.

26. An optical disc initialization method according to claim 18, further comprising:
attaching a cap to a portion of the optical disc located on inward side of the recording area thereof in order to prevent the laser beam from reaching that portion; and
radiating the laser beam onto the optical disc in this state.

27. An optical disc initialization method comprising:
providing a table on which an optical disc is placed, a light source including a plurality of emitters arranged in a row and each emitting a laser beam, and an optical system for introducing the laser beams from the light source and for forming on the optical disc an elongated elliptical laser spot having a length equal to or greater than a radial width of a recording area of the optical disc and having a major axis extending radially with respect to the optical disc; and
driving the table or driving the light source and the optical system in order to rotate the table relative to the light source and the optical system, whereby the upper surface of the optical disc is circumferentially scanned for initialization by means of the laser spot.

28. An optical disc initialization method according to claim 27, further comprising adjusting output energies of the plurality of emitters of the light source in order to reduce the radiation intensity imparted to the optical disc in accordance with the inward radial position of the optical disc.

29. An optical disc initialization method according to claim 28, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
adjustment of output energies of the plurality of emitters of the light source is individually performed for each of the plurality of semiconductor laser arrays.

30. An optical disc initialization method according to claim 27, further comprising:
detecting angular velocity of the table; and
controlling output energies of the plurality of emitters of the light source in accordance with the detected angular velocity in order to increase the output energies of the emitters with the angular velocity.

31. An optical disc initialization method according to claim 30, wherein
the light source includes a plurality of semiconductor laser arrays each having a plurality of emitters arranged in a row, the semiconductor laser arrays being disposed in such a manner that all the emitters among all the semiconductor laser arrays are arranged along the same direction; and
control of output energies of the emitters of the light source is individually performed for each of the plurality of semiconductor laser arrays.

32. An optical disc initialization method according to claim 27, further comprising tilting the optical axis of the laser beam from the light source and the optical system in a tangential direction of the optical disc in order to radiate an inclined laser beam onto the optical disc.

33. An optical disc initialization method according to claim 27, further comprising:
attaching a cap to a portion of the optical disc located on inward side of the recording area thereof in order to prevent the laser beam from reaching that portion; and
radiating the laser beam onto the optical disc in this state.
